(19) United States
(12) Patent Application Publication
(10) Pub. No.: US 2024/0174445 A1
(43) Pub. Date: May 30, 2024

(54) ADAPTIVE AUTONOMOUS MOBILE ROBOT TASKING

(71) Applicant: Dematic Corp., Grand Rapids, MI (US)

(72) Inventor: Eric A. Gatchalian, Ada, MI (US)

(21) Appl. No.: 18/525,029

(22) Filed: Nov. 30, 2023

Related U.S. Application Data
(60) Provisional application No. 63/385,455, filed on Nov. 30, 2022.

(51) Int. Cl. B65G 1/137; G05D 1/698; G05D 105/20; G05D 107/70

(52) U.S. Cl. CPC B65G 1/1373; G05D 1/6983; G05D 2105/20; G05D 2107/70

(57) ABSTRACT

A method and system are provided for task allocation for a material handling system with autonomous mobile robots (AMR) operating within a material handling facility. The AMRs are configured to self-select tasks to perform utilizing a computer based warehouse execution system (WES) utilizing a pending workflow list of tasks to be performed within the material handling facility. The AMRs include onboard computers for communicating with the WES and to self-select tasks from the pending workflow list. The AMR may be directed to a prioritized task or task queue, and the WES may lock an AMR to a task or task queue until the task or tasks are performed, or until the AMR determines that the AMR should be reassigned or otherwise relieved of the task or task queue. The AMRs are thus adapted to independently self-select tasks, where the AMR and/or WES may enable the AMR to self-select tasks.

### CROSS REFERENCE TO RELATED APPLICATION

The present application claims benefit of U.S. provisional application Ser. No. 63/385,455 filed Nov. 30, 2022, which is hereby incorporated herein by reference in its entirety.

### FIELD OF THE INVENTION

The present invention is directed to warehouse automation and, in particular, to movement of inventory/material throughout a warehouse. While the invention is illustrated for use with autonomous mobile robot (AMR) based systems it should be understood that this term broadly includes automated mobile vehicles, i.e., automated guided vehicles (AGV), drones, humanoid robots, and the like.

### BACKGROUND OF THE INVENTION

Automated guided vehicles (AGVs) have long been a successful solution to automatically move material to, from, and through manufacturing facilities, warehouses, distribution centers, and other applications. The AGV has evolved with new navigation technology, physical size/payload capabilities, environments and routing abilities and are now often referred to as autonomous mobile robots (AMR). The difference between AGVs and AMRs is one of degree and for the purpose of this document a reference to one shall include the other.

AMR vehicles are supplied in systems with multiple vehicles controlled in unison in a warehouse by an AMR Robot Controls System (RCS). The RCS includes a software module adapted to maintain knowledge of the warehouse layout as well as the location and status of all of the AMR vehicles. A warehouse also has a Warehouse Execution System (WES), a Warehouse Control System (WCS), and/or a Warehouse Management System (WMS) that are responsible for order fulfilment in the warehouse and overall control of inventory, respectively. It should be appreciated that each of the WES, WCS, and WMS, if present, may have unique, although potentially overlapping, responsibilities within the warehouse. However for clarity purposes, unless otherwise referenced by their specific name or acronym, the WES, WCS, and WMS are hereinafter referred to generally as the Warehouse Execution System (WES). The WES and the RCS are in communication in order to move inventory about the warehouse as required such as to maintain adequate stock of inventory in desired locations to support order fulfilment processes and/or to direct and conduct order fulfilment processes (e.g. picking).

In traditional order fulfillment solutions utilizing AMRs, the order fulfilment processes are implemented with the RCS using a centralized “fleet manager”, which globally tracks, manages, directs, and assigns tasks to the entire fleet of AMRs. For example, the fleet manager may manage and coordinates major functions of managing job requests, qualification, path/route planning, assignment of AMRs to regions of the facility, assignment of tasks to individual AMRs, and run-time navigation and path rerouting for the AMRs. The RCS receives all work/task requests from the WES for all work to be done by any of the AMRs. The fleet manager then processes the work/task requests and assigns each of the AMRs a load movement task or tasks to perform. The WMS and/or WES are reliant on status updates from the AMRs (e.g. an AMR subsystem). For example, the WMS and/or WES send transport requests to the AMR subsystem and wait for status updates and completion confirmations to be returned by the AMR subsystem.

As such, once an AMR has completed an assigned task, that particular AMR is reliant on the fleet manager to receive its next task, which may require the AMR to remain idle or wait until the fleet manager is available, such as for example until the fleet manager has sufficient computing power or resources to engage the waiting AMR. Any wait times or delays in task assignment from the fleet manager to one or more AMRs decreases the utilization of the AMR fleet which may contribute to order fulfillment cycle time increases and operational delays, thus resulting in decreased throughput. In this arrangement, the WES is reliant on a centralized fleet manager to assign tasks and control the AMR subsystem, thus requiring a linear, two-phase approach to maintaining a workflow list with the WES and then creating or modifying a job queue for AMRs via the fleet manager.

### SUMMARY OF THE INVENTION

The present invention provides an automated warehouse material handling and movement system and method of handling or moving material within a warehouse or material handling facility. The system and method utilize autonomous mobile robots (AMR) and an automated warehouse execution system (WES) to provide for dynamic tasking/task assignment/task selection of AMR in order to move material (e.g. inventory items and containers) within the warehouse. The system and method enable an operation-delineated or function-separated warehouse or order fulfilment system in which various control systems and computing hardware within the facility take on/handle certain functions in the facility which would otherwise typically be managed by a centralized control system, which as will be described in further detail, increases efficiency and throughput within the facility. At least a subset of the AMRs in the facility are adapted to self-select or “self-assign” themselves tasks to perform within the warehouse, without direct control from the WES. The WES, or other services and functions, manage orders, task lists, inventory information, and the like, and the AMRs are adapted to self-select or choose the most advantageous or efficient task to perform based on information supplied by the WES and/or other services and functions. Preferably, the WES provides a list or queue of tasks to an AMR, and the AMR is operable to self-select which of the tasks on queue to perform at any given time. In this manner, the WES and/or other services and functions do not require additional or relatively high levels of computing power (as compared to commonly known systems) to perform the functions of assigning individual tasks and optimizing task assignments to AMRs as they require additional work to do. Decisions and computations for a particular AMR relating to selection or assignment of tasks (e.g. tasks from an assigned task list or task queue) are performed at the WES and/or at the onboard computer of the particular AMR. AMR capable of self-selecting/self-assigning tasks may be referred to as “self-selecting AMR” for purposes of this disclosure. The system and method may utilize computer programs or logic to optimize and prioritize orders, tasks, inventory utilization, etc. within the facility. For example, the WES may utilize a program or logic adapted to identify and prioritize which tasks in a pending task list require the most immediate attention and to push those tasks to the priority position within a pending task workflow. Alternatively, the WES may utilize a program or logic adapted to identify and group a set of tasks into a task list or task queue that is optimized to be performed by a single AMR. The WES may manage, sequence, and prioritize more than one task list/queue within the pending task workflow.

Each task queue from the WES may be requested to be assigned to or selected by an AMR that is well-suited or advantageously positioned to perform the tasks on the queue. For example, an AMR may self-select a task queue from the WES if that AMR is well positioned relative to the tasks on the queue and if the AMR has capacity. Self-selecting AMR may utilize an AMR workflow, such as including a software program, algorithm, or logic, to dynamically or opportunistically request a task from a task queue (as provided by the WES), such as based on the location of the AMR and/or available load capacity of the AMR, for example. Optionally, a particular AMR may be “locked” or “temporarily assigned” to a particular one of the task queues. The AMR remains locked or temporarily assigned to that task queue until it has completed all of the self-selectable tasks on the task queue, or until the WES determines the AMR should be released from that queue, at which point the WES may unlock/release the AMR from that task queue, for example. Additionally, an AMR workflow self-selected/populated by a particular AMR may dictate or determine the area or region in which the AMR executes tasks. The AMR workflow may be dynamically updated (e.g. added to or subtracted from) to adjust each AMR's workflow based on operational changes, such as in the event of a rapid surge in order fulfilment tasks to be performed in the facility, for example. The system and method are not rigidly confined to a specific facility layout or material handling solution defined at an outset of a facility design, or to a particular type of task, and therefore may be readily reconfigured or adapted to meet the requirements of different facilities and/or for different type of inventory handling and transport or order fulfilment operations/functions.

In addition to the self-selecting AMRs, the material handling facility may include a robot controls system (RCS), which includes a fleet manager module and/or a traffic controller module that are adapted and operable to manage and control a fleet of AMRs made up of at least a subset of the AMRs in the facility. AMRs in communication with and enabled to be controlled by the RCS and fleet manager may be referred to as “fleet AMR” for purposes of this disclosure. The RCS and fleet manager may be provided to assign tasks to the fleet AMRs, and traffic controller may be provided to determine travel routes for the fleet AMRs, in addition to various other control functions for the fleet AMRs. The AMRs within the facility may be only self-selecting AMR, may be only fleet AMR, or may include an assortment of self-selecting AMRs and fleet AMRs. For example, some or all of the AMRs within the facility may be configured as only self-selecting AMRs. Preferably, some or all of the AMRs within the facility are configured as self-selecting AMRs that are also capable of communication with the RCS, the fleet manager, and the traffic controller to be either partially or fully controlled by the RCS. More preferably, all of the AMRs in the facility are self-selecting AMRs that are capable of communication with the RCS to be either partially or fully controlled by the RCS. In this preferable manner, a particular AMR is capable of self-selecting tasks when it is optimal or advantageous to do so, but may also be controlled by the RCS, and optionally the fleet manager, at periods when it is optimal or advantageous to do so, such as when an AMR is required in a different region of the facility, for example.

As an example of an operation-delineated or function-separated warehouse or order fulfilment system enabled by the system and methods of the present disclosure, the WES may solely handle task management and prioritization, the RCS may solely handle route planning for tasks self-selected by the AMRs, and the AMRs may be solely responsible for selecting and executing tasks within the facility. This arrangement may reduce facility CPU and resource demands, as one control or computer system is not responsible for most or all of the operations, processes, and functions within the facility. Accordingly, each of the separate operations, processes, and functions can be optimized independently at independent computing resources (e.g. the AMR computer can optimize the AMR workflow). In other words, business aspects (e.g. order receipt and management, inventory control, order urgency prioritization) can be managed substantially independent of the mechanical aspects of coordinating and performing material handling processes (e.g. transport of inventory into storage, or picking of goods for orders). Alternatively, the WES may take control of and manage all operations, processes, and functions, which may be beneficial or advantageous at times when throughput demand within the facility is at a minimum, for example. Optionally, a vehicle tasking system (VTS) may be provided in communication between the WES and the AMR subsystem to better facilitate the AMR subsystem, and individual AMR, to select opportunistic tasks for the WES workflow list.

The WES maintains information for each of the tasks, including the coordinates to which an AMR must travel to complete a task, such as to pick up loads. The WES may maintain more than one job queue based on the workflow list, such as different job queues for different regions of the warehouse facility, with each job queues having a prioritized and optimally sequenced task list for tasks to be completed in the corresponding region. The job queues create different demand requirements per region to provide adequate AMRs to perform the tasks in a particular region.

The WES may include a “next action” logic or algorithm that is configured to determine the most urgent task to be selected, and the next action logic may be integrated or linked with the AMRs onboard computers. The next action logic can take into account each AMR's capabilities/capacity, current location, future location, and/or configurable parameters (in addition to other aspects or parameters) to select the most urgent tasks to be selected, prioritized, and sequenced in the WES workflow list to be accessed for task self-selection by the AMRs. The WES may include a “move” logic or algorithm that is configured to monitor and regulate the allocation of AMRs concurrently working in each region/area of the facility in order to balance AMR resources in an optimal manner and to reduce traffic congestion in the regions.

According to one form of the present invention, an automated material handling system includes multiple autonomous mobile robots (AMR) for retrieving, transporting, and delivering items to and from locations within a material handling facility. The material handling system includes a warehouse execution system (WES) having a computer that is programed with computer code that is adapted to maintain a pending workflow list made up of tasks to be performed within the material handling facility. The material handling system includes an AMR subsystem made up of at least a subset of the AMRs in the automated material handling system. An onboard computer is provided with each AMR of the AMR subsystem, or at least some of the AMR of the subsystem. The onboard computer of each of AMR is in communication with the WES and are each programmed with computer code (e.g. a dynamic AMR workflow logic) that is adapted to select a task for the corresponding AMR to perform from the pending workflow list of the WES. A particular AMR is capable of performing the task selected by its onboard computer from the pending workflow list. Upon completion of a task selected by an onboard computer of an AMR, the adaptive or dynamic workflow logic of that AMR is adapted to select another task from the pending workflow list of the WES.

In one aspect, the material handling systems includes a robot controls system (RCS) having a computer that is programmed with computer code and includes a fleet manager. The fleet manager and computer code may include software or logic adapted to receive at least some of the tasks from the pending workflow list of the WES and to control at least some of the AMRs within the material handling facility with the fleet manager as a function of the tasks received by the fleet manager.

In another aspect, of the AMRs within the material handling facility, at least some of the AMRs that make up or form the AMR subsystem and at least some of the AMRs are not affiliated with the AMR subsystem in any manner. Alternatively, each of the AMRs within the material handling facility are affiliated with the AMR subsystem and are also controllable by the RCS. In this manner, an AMR may select and perform tasks independent of the RCS, an AMR may be assigned a task by the fleet manager and perform the task with oversight and/or control by the RCS and fleet manager, or an AMR may select tasks independent of the fleet manager, but may rely on the RCS for some data, information, or guidance, such as receiving a most efficient route for the AMR to travel to complete its self-selected task.

In another form of the present invention, a method is provided for task allocation for a material handling system having one or more autonomous mobile robots (AMR) for retrieving, transporting, and delivering items to and from locations within a material handling facility. The method includes using a computer based warehouse execution system (WES) that is programed with computer code (e.g. a workflow logic) adapted for maintaining a pending workflow list made up of tasks to be performed within the material handling facility. The method includes selecting a task from the pending workflow list of the WES with an onboard computer programmed with computer code onboard one of the AMRs. The computer code including an adaptive or dynamic AMR workflow logic that is provided for self-selecting either a task or a task list/queue (i.e. list of multiple tasks) from the WES pending workflow list when the AMR is in need of work to perform. The AMR carries out or performs the selected task(s) either independently or with some support from the material handling systems other resources.

In one aspect, in situations where the AMR has self-selected or been assigned a task queue from the WES, upon completion of one of the self-selected tasks from the task queue, the AMR onboard computer selects another task from the task queue. Selecting another task from the task queue is performed as a function of at least one chosen from (i) the location of the AMR within the material handling facility and (ii) the material handling capability of the AMR. In this aspect, the AMR may be locked or temporarily assigned to that particular task queue until (i) it completes each task on the queue; (ii) has completed all of the tasks on the queue for which it has capacity; or (iii) until the WES unlocks or releases the AMR from that task queue.

In another aspect, upon completion of the self-selected task, the AMR onboard computer selects another task from the pending workflow list of the WES. Selecting another task from the pending workflow list is performed as a function of at least one chosen from (i) the location of the AMR within the material handling facility and (ii) the material handling capability of the AMR.

In another aspect, utilizing a computer based robot controls system (RCS) that is programmed with computer code and includes a fleet manager application or module and/or a traffic control application or module, the RCS/fleet manager receives at least some of the tasks from the WES pending workflow list and controls at least some of the AMRs in the system with the fleet manager as a function of the tasks received by the fleet manager.

In one aspect, controlling at least some of the AMRs with the RCS or fleet manager includes one or more of the following functions (i) assigning tasks from the tasks received from the WES to at least some of the of AMRs, (ii) tracking statuses of tasks assigned to AMRs that were assigned tasks by the fleet manager, and (iii) assigning additional or new tasks from the tasks received by the fleet manager to at least some of the AMRs upon completion of a previous task.

In another aspect, upon completion of a self-selected task by an AMR, that AMR's onboard computer selects another task from the pending workflow list of the WES. In cooperation with the RCS, the RCS may track a status of a task self-selected by the onboard computer of the AMR. Upon completion of the self-selected task or tasks by that AMR, the WES may then relinquish control and “unlock” the AMR, after which the fleet manager may access and control the AMR to assign an additional or new task from the tasks received by the fleet manager. In other words, once an AMR has completed a self-selected task or list of self-selected/selectable tasks from a workflow it may be released by the WES from its locked condition and the AMR may then be accessed and controlled by the fleet manager.

In yet another aspect, upon completion of a task by an AMR that was assigned to that AMR by the fleet manager of the RCS, an onboard computer of that AMR may be self-selects another task directly from the pending workflow list of the WES. The AMR may “locked” or temporarily assigned to a self-selected/selectable workflow of task(s) such that the fleet manager is unable to control or request control of that particular AMR until it has completed all of the self-selectable tasks, or until the WES has unlocked the AMR from that workflow, for example.

In still another aspect, controlling the AMRs may include at least one chosen from (i) assigning tasks from the tasks received by the fleet manager to at least some of the AMRs, (ii) tracking statuses of tasks assigned to AMRs that were assigned tasks by the fleet manager, (iii) tracking statuses of tasks self-selected by an onboard computer of an AMR directly from the pending workflow list of the WES, and (iv) assigning additional or new tasks from the tasks received by the fleet manager to at least some of the AMRs upon completion of a previous task.

In yet still another aspect, the method may include determining, with the RCS, a route for an AMR to follow to perform a task self-selected by that AMR directly from the pending workflow list of the WES. In this manner, the AMR is substantially independent but relies to some degree on information or data provided by the RCS.

In another form of the present invention, selecting another task from a task queue (as provided from the prioritized/optimized/sequenced WES pending workflow list) includes determining with the AMR's onboard computer whether the AMR has capacity to pick the material required for at least one of the remaining tasks of the task queue. If the AMR lacks capacity, the onboard computer returns to determining whether the AMR has capacity to pick the material required for a different one of the remaining tasks on the task queue. If the AMR has capacity, the onboard computer selects one of the tasks from the task queue for which it has capacity in order to evaluate whether that selected task is an optimal or advantageous task for the AMR to undertake at the current iteration. After the onboard computer selects or is assigned a task queue, the WES and/or the onboard computer of the AMR may evaluate whether a particular task from the task queue, is an optimal or advantageous task for the AMR to undertake, such as based on the current location or capacity of the AMR. In this manner, the WES may continuously prioritize, optimize, and sequence the tasks on the task queue assigned to that AMR. The onboard computer may select the most optimal task remaining on the task queue, while the WES determines whether the AMR is in sufficiently close proximity to that selected task. If the AMR is not within sufficiently close proximity of the selected task, the onboard computer returns to determining whether the AMR has capacity to pick the material required for a different one of the tasks remaining on the task queue. If the AMR is within sufficiently close proximity of the selected task, the onboard computer adds the task to the dynamic AMR workflow and subsequently controls the AMR to perform the selected task. Upon completion of the selected task, the WES may determine whether the AMR has capacity to pick the material required for at least one of the tasks remaining on the task queue. It is contemplated that more or fewer of the evaluation functions described above may be computed or determined by the AMR onboard computer, independent of the WES, thereby further reducing the computing requirements and strain on the WES, for example. It is also contemplated that more or fewer of the tasks and functions performed by the WES and/or more or fewer of the tasks and functions performed by the onboard computer of the AMR may be handled or performed by the other of the WES or AMR onboard computer, or optionally the WES and AMR onboard computer may coordinate to perform some of such tasks and functions, for example.

In another aspect, if the AMR lacks capacity, the method includes determining with the WES whether the AMR has containers to drop off. If the AMR does not have containers to drop off, the onboard computer returns to select the next highest priority/different task on the task queue and the WES determining whether the AMR has capacity to pick the material required for that selected task. If the AMR has container(s) to drop off, the onboard computer adds the drop-off task to the dynamic AMR workflow and subsequently controls the AMR to drop off the container(s). Upon completion of dropping off the container(s), the onboard computer of the AMR selects the next highest priority task remaining on the task queue and the WES determines whether the AMR has capacity to pick the material required for that selected task.

In yet another aspect, the selecting another task from the pending workflow list may include determining with the onboard computer whether the AMR has containers to drop off, and if so, determining whether the AMR has capacity to make an additional pick while the containers to drop off remain on the AMR. If the AMR has capacity to perform a particular additional pick task while the containers to drop off remain on the AMR, the onboard computer controlling the AMR to select that particular pick task and perform that pick task simultaneously and/or in sequence with the drop of the containers.

In another form of the present invention, a method includes similar function as that of the previously discussed form of the present invention, and further includes that after the onboard computer of an AMR selects a task from the task queue, the method includes determining whether that AMR has capacity to perform at least one additional of the remaining tasks of the task queue. The tasks on the pending workflow list may include a material pick task in which the AMR must pick an item from a particular location within the material handling facility, and a container retrieval task in which the AMR retrieves a particular container or tote for receiving and retaining items, for example. A material pick task may include picking an item from a particular location into a container on the AMR. Determining whether the AMR has capacity may be performed by either the WES or with the onboard computer of the AMR.

In one aspect, if the AMR has capacity to perform at least one additional task from the pending workflow list, the method includes determining whether the AMR has containers to drop off. If the AMR does not have containers to drop off, the onboard computer of the AMR selects an additional task for the AMR to perform from the task queue and adds it to the dynamic AMR workflow. If the AMR has containers to drop off, either the WES or the onboard computer of the AMR prioritizes between (i) dropping off the containers versus (ii) selecting an additional task for the AMR to perform from the task queue while the containers to drop off remain on the AMR. Determining whether the AMR has containers to drop off may be performed by either the WES or with the onboard computer of the AMR.

In another aspect, prioritizing drop off versus picking includes the onboard computer of the AMR selecting an additional task for the AMR to perform from the WES pending workflow list of the WES while the containers to drop off remain on the AMR, and the onboard computer controlling the AMR to perform that additional task simultaneously and/or in sequence with the drop of the containers.

Accordingly, methods and a system are provided to enable an AMR to operate independently within a material handling facility, i.e. the AMR is not significantly reliant on an external or remote robot control system to select tasks to perform within the facility. The method provides a dynamic or adaptive AMR workflow logic that enables AMR to self-select tasks to perform in coordination with a computer based WES that maintains, organizes, and prioritizes a pending workflow list of tasks to be performed within the facility. The AMRs include onboard computers adapted to communicate with the WES and to self-select a task to perform from the pending workflow list. Preferably, the WES provides an optimized task queue or tasks for a particular AMR, wherein the AMR is operable to self-select an optimal task from the task queue to perform next. In this manner, the AMR do not require direction, control, or assignment from the WES or other control system to perform tasks or operations once they have been assigned to a task queue or workflow. Thus, the AMRs are adapted to independently self-select tasks upon completion of a prior task.

These and other objects, advantages, purposes, and features of this invention will become apparent upon review of the following specification in conjunction with the drawings.

### BRIEF DESCRIPTION OF THE DRAWINGS

FIG. 1 is a diagram of a method for the assignment or selection of tasks to be performed by an autonomous mobile robot (AMR), in accordance with an aspect of the present invention;

FIG. 2 is a diagram of another method for the assignment or selection of tasks to be performed by an autonomous mobile robot (AMR), in accordance with an aspect of the present invention;

FIG. 3 is a diagram of another method for the assignment or selection of tasks to be performed by an autonomous mobile robot (AMR), in accordance with an aspect of the present invention;

FIG. 4 is a diagram of another method for the assignment or selection of tasks to be performed by an autonomous mobile robot (AMR), in accordance with an aspect of the present invention;

FIG. 5 is a schematic diagram of an order fulfilment system having AMR enabled to self-select tasks to perform, in accordance with an aspect of the present invention;

FIG. 6 is another schematic diagram of the order fulfilment system of FIG. 5, including multiple workflows, in accordance with an aspect of the present invention;

FIG. 7 is another schematic diagram of the order fulfilment system of FIG. 5, including descriptions of different functions affecting AMR task self-selection, in accordance with an aspect of the present invention;

FIG. 8 is another schematic diagram of the order fulfilment system of FIG. 5;

FIG. 9 is a schematic diagram of an exemplary workflow for a material handling facility utilizing human operators, as known in the art; and

FIG. 10 is a schematic diagram of an order fulfilment system having AMR controlled by a centralized fleet manager and traffic controller, as known in the art.

### DESCRIPTION OF THE PREFERRED EMBODIMENTS

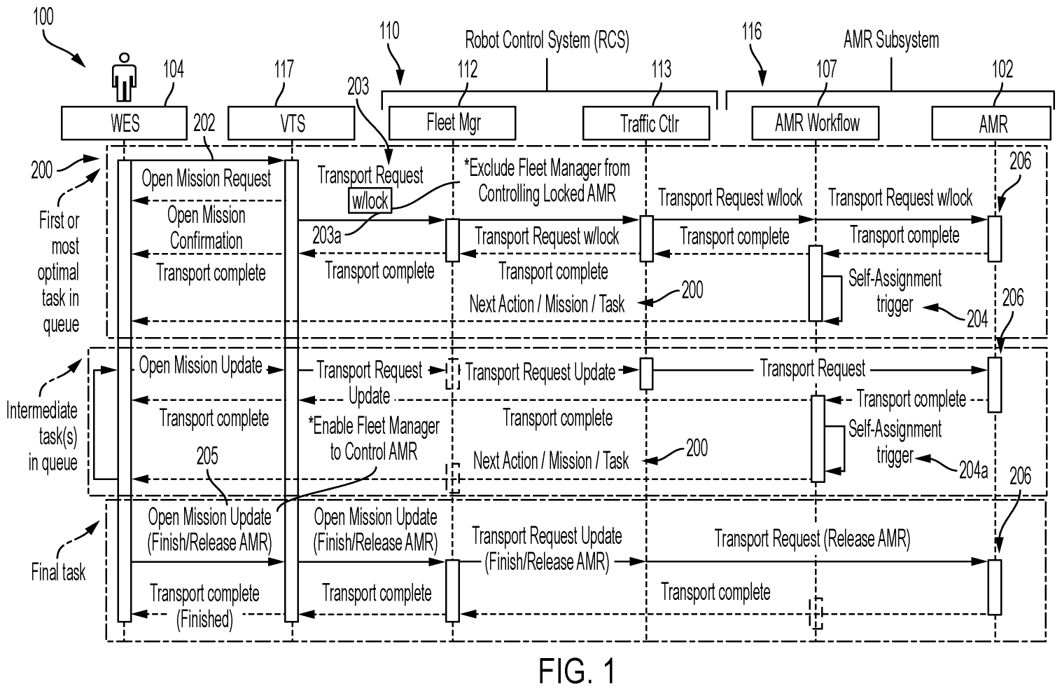

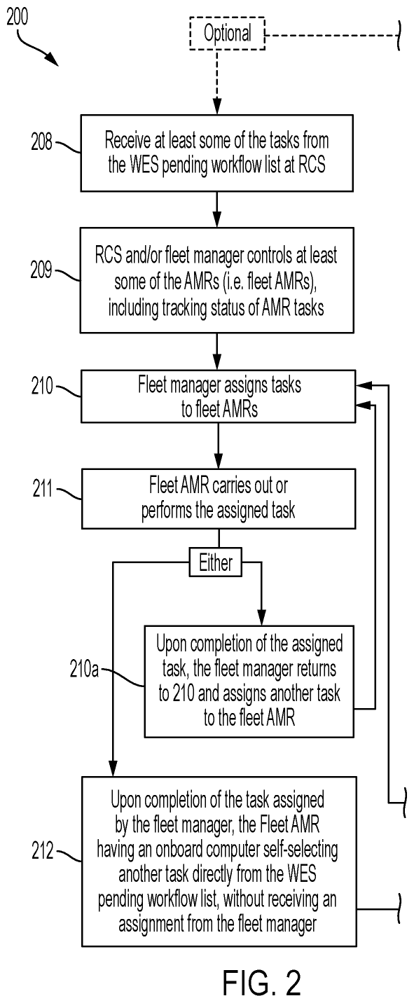

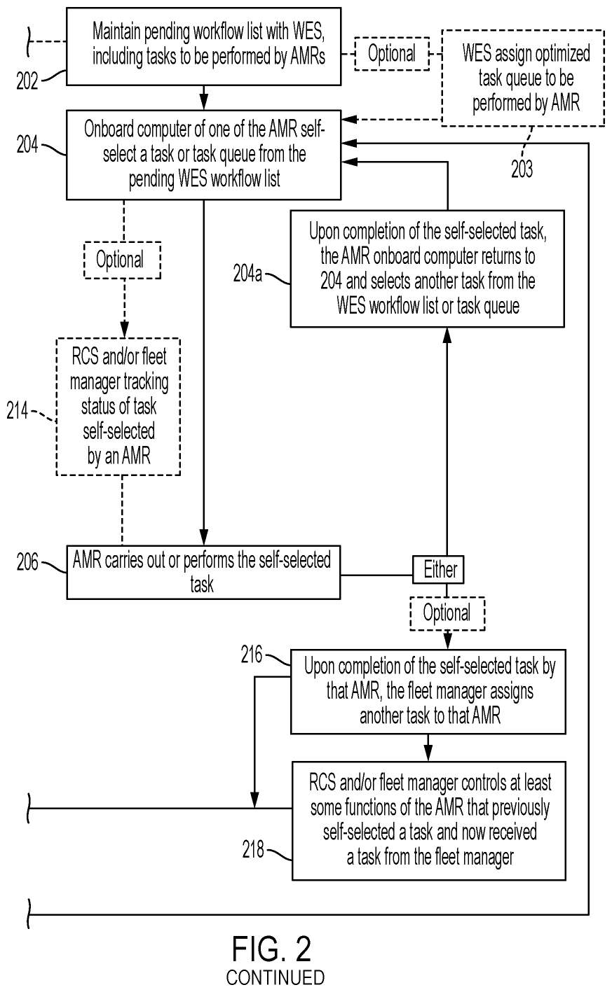

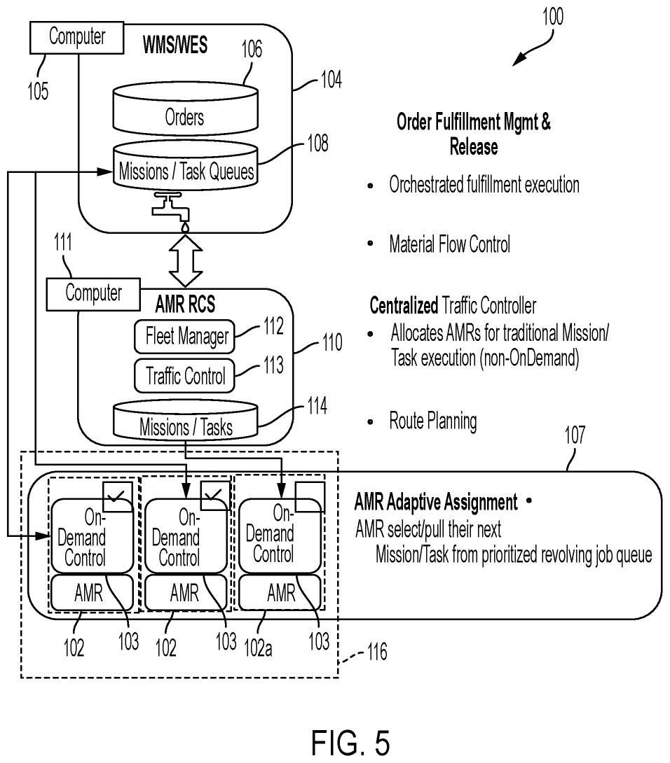

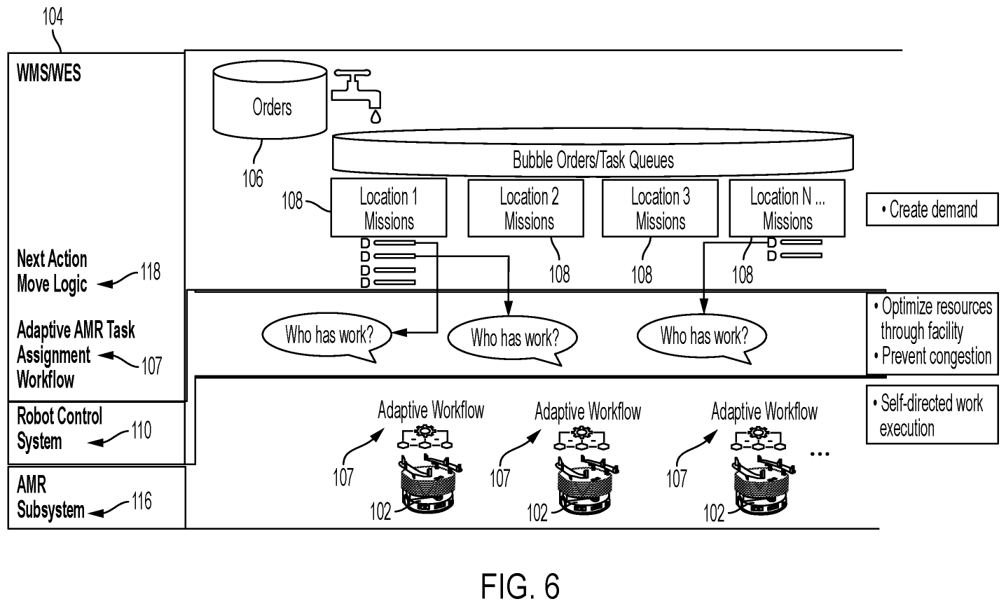

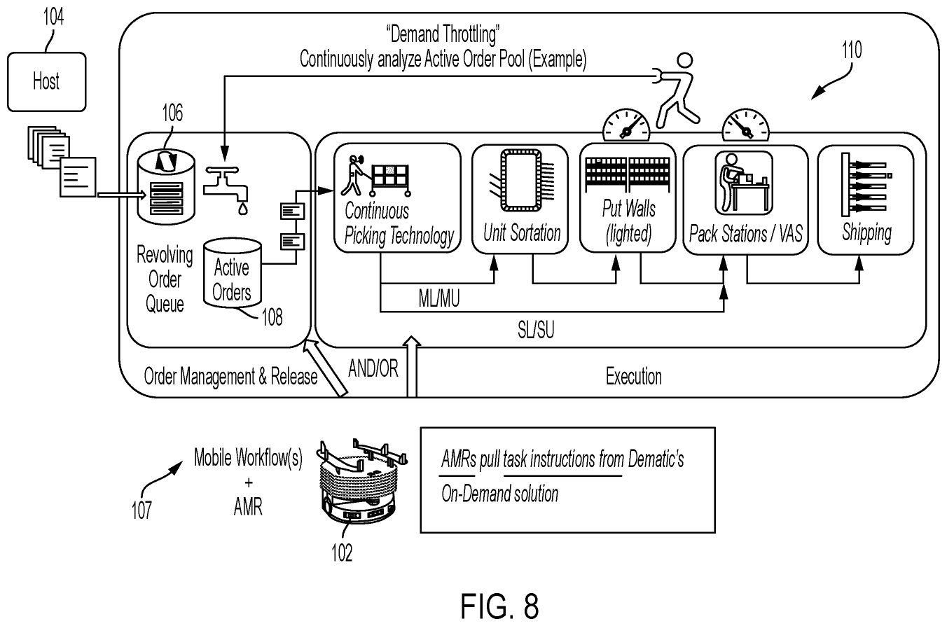

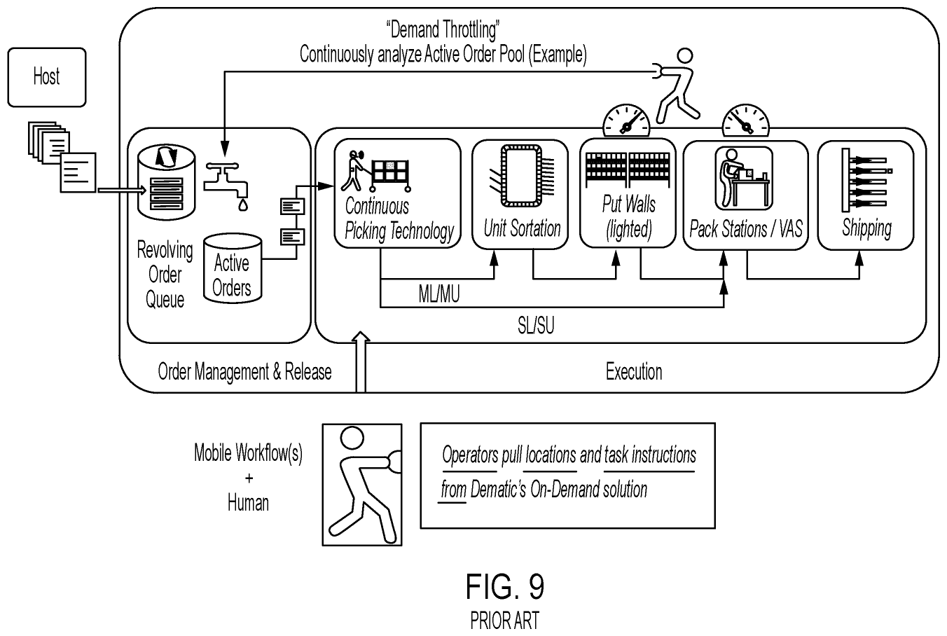

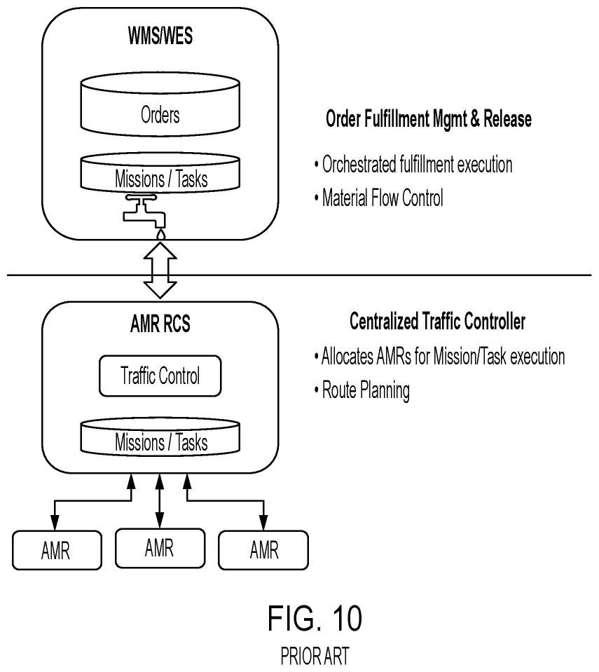

Referring now to the drawings and the illustrative embodiments depicted therein, an automated warehouse material handling and movement system 100 (FIGS. 5-8) and method 200 (FIGS. 1 and 2) are provided for handling or moving material within a warehouse or material handling facility. The system 100 includes multiple autonomous mobile robots (AMR) 102 for carrying out tasks and an automated warehouse execution system (WES) 104 to provide for dynamic tasking/task assignment/task selection for the AMR 102 in order to move material (e.g. inventory items, containers, pallets, shelves, and the like) within the warehouse. At least a subset of the AMRs 102, and preferably all of the AMRs, in the facility are adapted to self-select tasks to perform within the warehouse, without direct control from the WES 104 or other services or functions in the warehouse. The WES 104 and other services/functions manage orders (e.g. a list of pending orders 106, such as for e-commerce orders and/or retail orders), task lists (such as a pending workflow list 108), inventory information, and the like. within the warehouse. The AMRs 102 are adapted to self-select or choose the most advantageous or most efficient task to perform based on information supplied by the WES 104 and/or other services and functions. In this manner, at least some of the decisions and computations for a particular AMR relating to selection or assignment of tasks can be performed onboard a particular AMR, as opposed to the WES 104 or other services/functions performing task assignment, while the WES 104 provides an optimized task list or queue of tasks for the AMR 102 to select from and perform based on the location and capacity of the AMR 102.

The material handling facility of the illustrative embodiments of FIGS. 1 and 5-8 include a robot controls system (RCS) 110 with a fleet manager function, application, or module 112 and a traffic control function, application, or module 113, where the fleet manager 112 and traffic control 113 may each comprise one or more separate software programs. The RCS 110 includes or provides mission or task information 114 (such as received from the pending workflow list 108, for example) for managing and controlling AMRs 102 in the warehouse. The RCS 110 may be in selective communication with all of the AMRs 102 in the facility, or only a subset of the AMRs in the facility. For purposes of this disclosure, an AMR 102 in communication with and enabled to be controlled by the RCS 110 fleet manager 112, and traffic control 113 may be referred to as “fleet AMR” 102a when practical or appropriate to differentiate from other AMR being discussed in a given context. For example, a particular AMR 102 may be capable of self-selecting tasks when it is optimal or advantageous to do so, but may also be controllable by the RCS 110, fleet manager 112, and traffic control 113 at periods when it is optimal or advantageous to do so, such as when an AMR 102 is required in a different region of the facility, for example. It will be appreciated that the RCS 110, fleet manager 112, and traffic control 113 may be omitted, such that each AMR 102 in the facility is responsible and operable to self-select its own tasks from a pending task list provided by the WES 104.

Referring to the illustrative embodiment of FIGS. 5-8, the automated material handling system 100 includes multiple AMR 102 for retrieving, transporting, and delivering items to and from locations within the material handling facility. The WES 104 includes a computer 105 device that is programed with computer code that is adapted to maintain a pending workflow list 108 made up of tasks, and optimized task lists or queues, to be performed within the material handling facility. For example, the tasks on the pending workflow list 108 may include a material pick task in which the AMR 102 must pick an item from a particular location within the material handling facility, and a container retrieval task in which the AMR retrieves a particular container for receiving and retaining items. As another example, a material pick task may include picking an item from a particular location into a container on the AMR.

The computer 105 device of the WES 104 may comprise one or more processors as well as hardware and software, including for performing the operations discussed herein, and may be configured as one or more interoperating computers and/or servers. The material handling system 100 includes an AMR subsystem 116 made up of some or all of the AMRs 102 of the system 100. Each AMR 102 of the subsystem 116 includes an onboard robot operating system (ROS) with an onboard computer device 103, which is in communication with the WES 104. The AMR onboard computers 103 may comprise one or more processors as well as hardware and software, including for performing the operations discussed herein. Each AMR onboard computer 103 is programmed with computer code including an AMR workflow 107 (FIGS. 5-8), such as including an algorithm or logic, that is adapted to dynamically select a task to perform from the assigned task queue (as provided or self-selected from the pending workflow list 108 of the WES 104), and may maintain a pending task list of previously selected tasks for the AMR (i.e. an AMR workflow list). In contrast to traditional AMR systems, as commonly known, which utilize a centralized fleet manager and traffic controller model in which the centralized fleet manager performs the functions of monitoring all AMRs, assigning tasks to all AMRs, and the traffic controller planning and directing the travel routes of the AMRs.

The AMR computer code is adapted to only select a task of which that particular AMR 102 is capable of performing at a given time (e.g. if the AMR has capacity to pick a particular item). For example, the AMR onboard computer 103 and/or WES 104 may cooperate to select a task based on a location of the AMR 102 within the facility relative to a task on the task queue or the load capacity of the AMR 102 relative to the load requirements of a task on the task queue. Upon completion of a task selected by its onboard computer 103, the onboard computer of that AMR 102 is further adapted to select another or subsequent task from the task queue currently assigned to the AMR 102. The WES 104 may assign an optimized task queue to each AMR 102, or the individual AMR 102 may self-select an opportune task queue from the WES pending workflow list 108. Alternatively, the WES 104 may filter tasks in the pending workflow list 108 into filtered queues based on pre-defined attributes required or necessary to perform each particular task. An AMR 102 may be enabled to self-select an opportune task from one or more of the filtered queues. The WES 104 may “lock” or “temporarily assign” an AMR 102 to a particular task queue or to a particular filtered queue, such that the AMR 102 is excluded from control by the fleet manager 112 (such as after an initial task assignment is made by the fleet manager) and such that the AMR 102 may only self-select tasks from the assigned dynamic task queue or filtered queue that is assigned to the AMR (and to which the AMR 102 is locked). The WES 104 may release or unlock the AMR 102 at any time, such as after the AMR 102 completes all tasks on the task queue, or when the WES 104 otherwise determines that it is advantageous to do so, for example.

The material handling system 100 of FIGS. 5-8 includes the robot controls system (RCS) 110 having a computer device 111 (or multiple independent and remote computer devices) that is programmed with computer code and provides a fleet management system or fleet manager 112. The computer device 111 of the RCS 110 may comprise one or more processors as well as hardware and software, including for performing the operations discussed herein. The fleet manager 112 and/or computer code are adapted to receive at least some of the tasks from the pending workflow list 108 of the WES 104 and to control at least some of the AMRs, i.e. fleet AMRs 102a, within the material handling facility. The fleet manager 112 controls those fleet AMRs as a function of the tasks received by the fleet manager 112 from the workflow list 108.

In one exemplary embodiment of a material handling facility, a subset of the AMRs within the material handling facility make up or form the AMR subsystem 116 and the remainder of the AMRs (i.e. non-AMR subsystem AMR) are not affiliated with the AMR subsystem 116 in any manner. As such, the AMR 102 of the AMR subsystem 116 are wholly self-reliant for task-selection from the pending workflow list 108 of the WES 104, and the non-AMR subsystem AMR 102 are reliant on the fleet manager 112 of the RCS 110 for task assignments.

Alternatively, in another exemplary embodiment of a material handling facility, each of the AMRs within the material handling facility are affiliated with the AMR subsystem 116 and are also controllable by the RCS 110, fleet manager 112, and traffic controller 113. In other words, each of the AMRs in this exemplary embodiment are fleet AMRs 102a. In this manner, any AMR in the facility may self-select and perform tasks directly from the assigned dynamic task queue to which the AMR is locked, independent of the fleet manager 112. Also, any AMR in the facility may be assigned a task by the fleet manager 112 (as received by the fleet manager from the pending workflow list 108 of the WES 104) and perform the task with oversight and/or control by the fleet manager 112 and traffic controller 113. In some circumstances, a fleet AMR 102a within the facility may self-select tasks directly from a dynamic task queue to which the AMR is locked, independent of the fleet manager 112, but may nonetheless rely on the RCS 110 and/or traffic controller 113 for some data, information, and/or guidance, such as receiving a most efficient route for that AMR 102a to travel to complete its self-selected task. The RCS 110 fleet manager 112, and/or traffic controller 113 may be provided to assign tasks to the fleet AMRs 102a, control operations of the fleet AMRs 102a and to determine travel routes for the fleet AMRs 102a, in addition to various other control functions for the fleet AMRs 102a.

In one preferred embodiment, an AMR 102a may be enabled to self-select tasks from the task queue assigned to that AMR for each task after the initial task is performed. In this embodiment, the fleet manager 112 may be provided control of the AMR 102a initially and to assign a first or priority task from the assigned task queue to the AMR to perform first, from that point on, the AMR 102a may self-select all of the remaining tasks (without control from the fleet manager 112), at least until the AMR 102a is released/unlocked 205 (FIG. 1) from the assigned task queue, as will be described in further detail below.

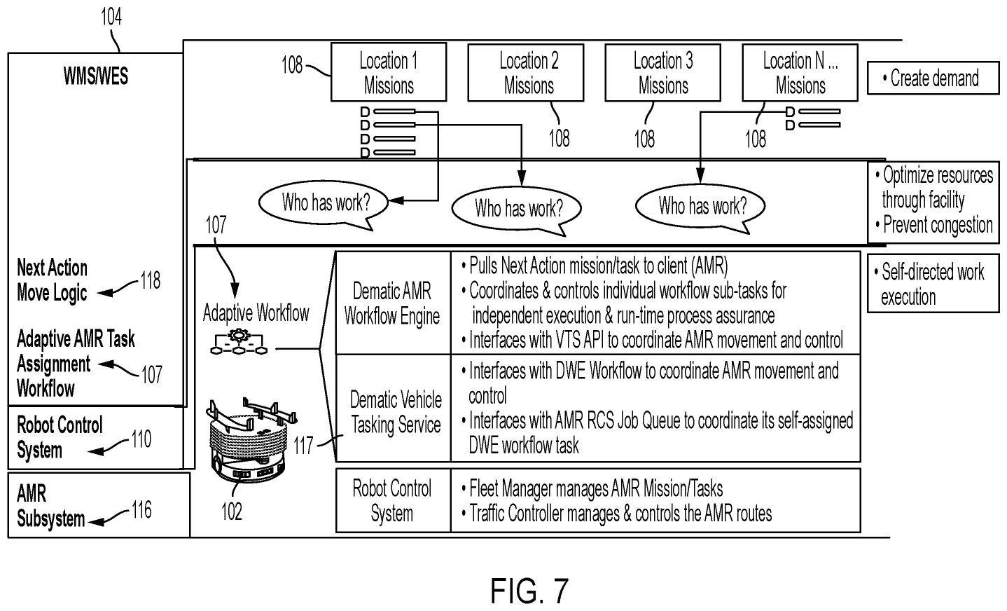

The system 100 utilizes a vehicle tasking service (VTS) 117 that interfaces between the WES 104 and the RCS 110 (e.g. fleet manager 112 and traffic controller 113) and AMR subsystem 116 (e.g. AMRs 102 and AMR workflow(s) 107) or individual AMRs 102 (FIGS. 1 and 7). The WES 104 creates and dynamically manages an open-ended mission request which it initially sends to the VTS 117 in the form of a missions/task queue. The mission request (i.e. task queue) is open-ended in that each of the tasks on the task queue are available to be selected by an AMR 102 or the AMR subsystem 116 at the AMR/subsystem's disposal (e.g. when an AMR/the subsystem determines that a particular task on the mission/task queue is opportune). The VTS 117 is configured to translate or transform the task queue operation instructions into a form or language that is readable by the RCS 110 and thereby the AMRs 102 and may comprise a computer program or programs residing on a computer of the system 100. In some embodiments, the RCS 110 and/or AMR subsystem 116 may receive the translated open-ended mission request from the VTS 117. The WES 104 and VTS 117 cooperate to perform the function of assigning a particular mission/task queue to an AMR 102. In this exemplary embodiment of FIG. 1, the WES 104 assigns a dynamic workflow protocol (e.g. task queue) to each AMR 102 with assistance of the VTS 117, and alternatively in the exemplary embodiment of FIG. 2, the WES 104 may optionally assign a dynamic workflow protocol (e.g. task queue) to each AMR 102 with assistance of the VTS 117 or the individual AMR 102 may self-select a dynamic workflow protocol (e.g. task queue) from the WES 104 and receive translated instructions for how to perform the tasks on the task queue from the VTS 117. The VTS 117 may continue to facilitate the performance of the tasking assignment by the AMR assigned the mission, such as providing and translating particular operation requirements and instructions for the mission (e.g. location of an item to pick from a storage location).

Once a task queue is provided or assigned to an AMR 102, a first, highest priority task may be assigned 203 to the AMR 102 (FIGS. 1 and 2). The assignment of a first task from the assigned task queue at 203 may be performed by the WES 104, by the fleet manager 112, or alternatively the AMR 102 may be enabled to self-select the highest priority task from the task queue to perform first. Upon assignment or selection of the first task at 203, the WES 104 “locks” or “temporarily assigns” 203a that AMR 102 to the assigned task queue, such that the AMR 102 is excluded from control by the fleet manager 112 and such that the AMR 102 may only self-select tasks from the assigned dynamic task queue to which the AMR is locked. While the computer 105 of the WES 104 is described herein as locking 203a the AMR to a task queue, it should be appreciated that the RCS 110 or AMR subsystem 116 may provide input to or communicate with the WES 104 in regard to the locking. For example, the WES 104 may wait for the fleet manager 112 to assign the first, highest priority task from the task queue to the AMR 102 to be performed, and once that first task is assigned the WES 104 may request permission from the fleet manager 112 to lock that AMR 102 to its assigned task queue. Accordingly, the fleet manager 112 may cede control of the AMR 102 to the WES 104. With permission from the fleet manager 112 the WES 104 may then lock that AMR 102 to its assigned task queue, and the fleet manager 112 will not have any control of the AMR 102 while it remains locked to the assigned task queue. The AMR 102 is locked or temporarily assigned 203a to that task queue in that it continues to select and perform tasks from the assigned task queue until it is released/unlocked 205 from that queue by the WES 104 (FIG. 1). For examples, the WES 104 may release/unlock 205 an AMR 102 from its assigned task queue once the AMR 102 has completed all of the self-selectable tasks on the task queue, until the AMR 102 no longer has capacity or advantageous positioning to perform remaining tasks on the task queue, or until the WES 104 (or other function in the system 100, e.g. the traffic controller 113 in cooperation with the WES 104) determines the AMR 102 should be released from that queue. Accordingly, the WES 104 may then unlock/release 205 the AMR from that task queue, such that the fleet manager 112 may then access the released AMR 102 and assign it a task to perform.

The AMR dynamic workflow protocol 107 selects one or more prioritized tasks from the task queue. The dynamic workflow protocol is integrated with a “move” logic or algorithm, which may be provided with the computer 105 of the WES 104 (an exemplary embodiment of the move logic is described in further detail below) and/or with the onboard computer 103. The dynamic workflow protocol and move logic coordinate to direct the AMR 102 to the area within the facility that the AMR should perform its missions/tasks. The dynamic workflow protocol and/or move logic are integrated with a “next action logic” or algorithm, which may be provided with the computer 105 of the WMS 104 (an exemplary embodiment of the next action logic is described in further detail below with respect to method 200) and/or with the onboard computer 103. The move logic and next action logic coordinate to allocate AMRs 102 to areas/regions of the facility that require more of fewer AMRs (e.g. allocating AMR based on work-in-progress (WIP) demands on the workflow list 108). Allocation of AMR 102 may include locking an AMR to a particular task queue, or unlocking an AMR from a task queue and making it available for assignment to a different task or task queue. The move logic and next action logic may be adapted to control the AMRs 102 based on congestion in a particular area/region of the facility, such as at a higher hierarchal level than would be performed by the RCS in a typical system. The WES 104 interfaces/integrates with the VTS 117 to update the dynamic workflow protocol for a particular AMR 102 to enable the AMR ROS to manage and coordinate its task self-selection and task execution.

It is contemplated that more or fewer of the tasks and functions performed by the WES 104 and/or more or fewer of the tasks and functions performed by the onboard computer 103 of the AMR 102 in reference to system 100 and the illustrative embodiment of FIGS. 1 and 5-8 may be handled or performed by the other of the WES 104 or AMR onboard computer 103, or optionally the WES 104 and AMR onboard computer 103 may coordinate to perform some of such tasks and functions, for example.

Referring to the illustrative embodiment of FIGS. 1 and 2, the method 200 is provided for task allocation/selection for AMR 102 in a material handling system to facilitate retrieving, transporting, and delivering items to and from locations within a material handling facility. The method 200 is directed to self-selecting or self-tasking AMR 102 that are adapted to communicate directly with a warehouse execution system (WES) 104 and to select a task from an assigned, optimized task queue (as provided or selected from the pending workflow list 108 maintained at the WES 104). The method 200 includes using a computer 105 of the WES 104 that is programed with computer code to maintain 202 the pending workflow list 108, which is made up of tasks to be performed within the material handling facility, including tasks to be performed by AMRs 102. Method 200 includes providing 203 an optimized task queue to an AMR 102, either via the WES 104 assigning the task queue or the onboard computer 103 of the AMR 102 self-selecting a task queue from the WES 104. Once the optimized task queue is provided at 203, the WES 104 may optionally lock or temporarily assign 203a the AMR 102 to that task queue (FIG. 1), such as that the fleet manager 112 is excluded from control of that AMR 102 while it is locked to the task queue, for example. The method 200 includes selecting 204 a task from the optimized task queue with an onboard computer 103 of one of the AMRs 102. Optionally, the AMR onboard computer 103 is programmed with computer code that is adapted for communicating with the WES 104 and accessing the pending workflow list 108 and/or task queue when the AMR 102 is in need of a task or tasks to perform. The AMR carries 206 out or performs the self-selected task. Upon completion of the self-selected task by the AMR, the AMRs 102 onboard computer 103 communicates with or accesses the task queue and selects 204a another task to complete. Selecting another task 204a from the task queue may be performed simply by selecting the next, highest priority task to be performed (e.g. as optimized, updated, and provided by the WES 104 based on the location of the AMR 102 within the material handling facility and/or the material handling capability/capacity of the AMR 102, in addition to other criteria), or independently by the onboard computer 103 as a function of the location of the AMR 102 within the material handling facility and/or the material handling capability/capacity of the AMR 102, in addition to other criteria.

In some aspects, the method 200 may include using a computer based robot controls system (RCS) that is programmed with computer code and includes a fleet manager application or module 112 and/or a traffic control application or module 113 to receive 208 at least some of or a subset of the tasks from the pending workflow list 108 from the WES 104 (FIGS. 1 and 2). Based on the subset of tasks received by the fleet manager 112 at 208, the RCS controls 209 at least some of the AMRs 102 in the facility to facilitate performance or completion 211 of tasks by the AMRs. Controlling 209 the AMRs 102 may include one or more of the following functions: (i) assigning tasks 210 from the tasks received by the fleet manager 112 from the WES 104 to fleet AMRs 102a (i.e. AMRs controllable by the fleet manager as described above), (ii) tracking statuses of tasks assigned to fleet AMRs 102a that were assigned tasks by the fleet manager 112, and/or (iii) assigning additional or new tasks 210a from the tasks received by the fleet manager 112 to fleet AMRs 102a upon them completing a previous task. The AMR carries 211 out or performs the task assigned to it by the fleet manager 112. Upon completion of the assigned task, the fleet manager 112 assigns 210a another task to the AMR 102.

Alternatively, or in addition to steps 208 and 210, upon completion of an assigned task from the fleet manager 112, the method 200 may include an onboard computer 103 of a fleet AMR 102a selecting 212 another task or another task queue directly from the pending workflow list 108 of the WES 104, without receiving an assignment from the fleet manager 112. The method 200 may further include the fleet manager 112 and/or the RCS 110 tracking 214 a status of a task self-selected by an onboard computer 103 of an AMR, and upon completion of the self-selected task by that AMR, the fleet manager 112 assigns 216 an additional or new task from the tasks received by the fleet manager 112 (from the pending workflow list 108) to that AMR 102. Based on the subset of tasks received by the fleet manager 112 at 208, the RCS may control 218 at least some functions or operations of the fleet AMRs 102a that received tasks from the fleet manager 112 at 216. In this aspect, controlling the AMRs at 218 may include one or more of the following functions: (i) assigning tasks from the tasks received by the fleet manager 112 to at least some of the AMRs 102, (ii) tracking statuses of tasks assigned to AMRs 102 by the fleet manager 112, (iii) tracking statuses with the RCS 110 of tasks self-selected by an onboard computer 103 of an AMR 102 directly from the pending workflow list 108 of the WES 104, and/or (iv) assigning additional or new tasks from the tasks received by the fleet manager 112 to at least some of the AMRs 102 upon completion of a previous task.

Optionally and preferably, the method 200 includes determining, with the traffic controller 113, a route for the AMR 102 to follow to perform the task self-selected by that AMR 102. In this manner, the AMR 102 performs the function of self-selecting 204 a task independent of the fleet manager 112, but relies on other resources provided by the RCS 110 and/or traffic controller 113 to implement the task (e.g. receiving directions or a travel path to follow to complete the self-selected task). As such, the RCS 110 and/or traffic controller 113 can coordinate AMRs to ensure that there are no conflicts as individual AMRs 102 complete their tasks in similar locations or regions of the warehouse facility.

It is contemplated that more or fewer of the tasks and functions performed by the WES 104 and/or more or fewer of the tasks and functions performed by the onboard computer 103 of the AMR 102 in reference to method 200 and the illustrative embodiment of FIGS. 1 and 2 may be handled or performed by the other of the WES 104 or AMR onboard computer 103, or optionally the WES 104 and AMR onboard computer 103 may coordinate to perform some of such tasks and functions, for example.

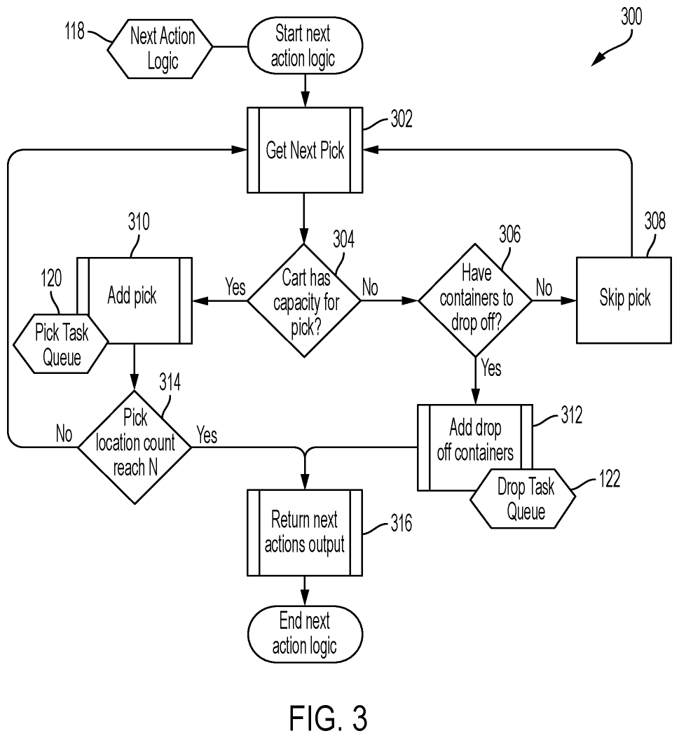

Referring now to the illustrative embodiment of FIG. 3, an exemplary method 300 is directed to selecting pick tasks from the pending workflow list 108 and/or determining whether to drop off a container or item carried on the AMR 102. Method 300 may be incorporated into method 200 of FIGS. 1 and 2 for selecting a task at 204 and/or selecting another task at 204a or 212 from the pending workflow list 108 (e.g. for pick tasks). For purposes of this disclosure, method 300 will be discussed as though integrated into method 200 of FIGS. 1 and 2 and utilizing the system 100 of FIGS. 5-8. However, it will be appreciated that method 300 of FIG. 3 may be adapted for other systems and functions to which it is well-suited. In certain aspects, method 300 may be referred to as including or providing a “next action” logic or algorithm 118 for determining the next action/task/mission for an AMR 102 to perform or add to its workflow list. The next action logic 118 is controlled and performed by and/or integrated with the AMR workflow 107.

While method 300, as exemplified in the illustrative embodiment of FIG. 3, is directed to picking tasks and/or drop-off tasks, it will be appreciated that the framework and concept of the next action algorithm 118 may be adapted for various order fulfillment and material handling tasks and for different use cases than detailed herein. For example, method 300 may be adapted for sequencing, prioritizing, and/or optimizing inventory putaway tasks to place inventory items into storage, or adapted for sequencing and optimizing packing and shipping tasks, such as loading a transport vehicle with picked and packaged orders. It will be appreciated that, similar to that described above for method 200, the WES 104 may assign or provide optimized task queues to AMRs 102 (and lock/unlock 203a that AMR to/from a task queue), or an AMR 102 may self-select a task queue from those available in the pending workflow list 108 of the WES 104. For purposes of discussion of method 300, the function of assigning/selecting a task queue for a particular AMR 102 will be directed to an AMR 102 self-selecting a task queue from the pending workflow list 108 of the WES 104. It will be appreciated that the pick task queue 120 and drop-off task queue 122 of FIG. 3 are provided as examples of open-ended mission requests/task queues as described above with respect to system 100 and method 200, and are not intended to be limiting as to the plurality of potential task types to which system 100, method 200, or method 300 may be adapted to perform.

Method 300 includes selecting at 302 a first or highest priority pick task from the pending workflow list 108, in which the WES 104 maintains 202 the list 108 in a prioritized manner (such as prioritizing based on the urgency with which customers need their orders, for example). After selecting the highest priority pick task at 302, either the computer 105 of the WES 104 or the onboard computer 103 of that particular AMR 102 determines at 304 whether the AMR has capacity in a pick task queue 120 or physical capacity to pick the material required for the selected pick task (FIG. 3). If the AMR 102 lacks capacity for the selected pick task, the WES computer 105 and/or onboard computer 103 determines at 306 whether the AMR 102 has containers or items to drop off (such as at an opportunistic or advantageous location nearby the AMR, for example). If the AMR 102 does not have containers to drop off, the onboard computer 103 of the AMR 102 skips 308 that pick task and returns to step 302 to select another pick task from the task queue (e.g. the next highest priority pick task on the queue) and proceeds again to step 304, etc. If the WES computer 105 and/or onboard computer 103 determines at 304 that the AMR 102 has capacity, the computer 103 selects or adds at 310 that pick task to perform and the AMR 102 subsequently performs or carries 206 out that self-selected task. If it is determined at 306 that the AMR 102 has containers or items to drop off, the WES computer 105 or computer 103 adds or selects at 312 particular containers or items to drop off to a drop-off queue 122, such as based on the current location of the AMR relative to required drop-off locations of containers or items on the AMR, for example.

The AMR 102 (or WES computer 105) may be adapted for queuing several active tasks at any given time, such as queueing multiple pick tasks to be performed when the location of the AMR 102 is most advantageous to perform each pick task or holding multiple containers to be dropped off in an opportunistic sequence as the AMR 102 completes tasks by dropping off other containers in the drop-off queue 122 or retrieving containers on the pick task queue 120. In this manner, the WES computer 105 and/or AMR onboard computer 103 may be constantly performing and computing steps 302 through 316 of method 300 to maintain a full pick task queue 120 and maximize utilization of the AMRs 102 capacity. Thus, at step 310, the WES computer 105 and/or AMR onboard computer 103 may be adding the selected pick task to a partial queue of pick tasks previously selected or added. After the onboard computer 103 has selected or added at 310 the pick task, the WES computer 105 and/or AMR onboard computer 103 determines 314 if the pick task queue 120 of the AMR 102 is full. If not full, the computer 103 returns to step 302 to select another task from the task queue (e.g. the next highest priority task on the list 108) and proceeds again to step 304, etc.

If it is determined at 314 that the pick task queue 120 for the AMR is full and/or it is determined at 306 that the AMR 102 has containers or items in queue 122 to drop off, the computer 103 controls 316 the AMR 102 (optionally, in cooperation with the WES 104, VTS 117, and/or traffic controller 113) to perform or carry out 206 at least one of the pick tasks in the AMRs pick task queue 120 and/or to drop off one or more of the containers on the AMR drop-off queue 122 at the required location(s) in the facility. In an exemplary embodiment, if the AMR has containers to drop off, the WES computer 105 and/or onboard computer 103 of the AMR may prioritize the dropping off of the container(s) versus selecting another or an additional task for the AMR 102 to perform from the task queue while the containers to drop off remain on the AMR 102. The onboard computer 103 may control the AMR 102 to perform one or more pick task simultaneously and/or in sequence with one or more drop-off task. Once one or more tasks are performed at 206 (FIGS. 1 and 2) by the AMR 102 (e.g. pick tasks or drop of tasks), the onboard computer 103 of the AMR 102 may return to step 302 (FIG. 3) to select another task(s) at 204 (FIGS. 1 and 2), or alternatively, the RCS computer 111 and fleet manager 112 may intervene and assign a task or tasks to the AMR 102 at 216 (FIGS. 1 and 2), such as when the AMR 102 is not locked or temporarily assigned to a task queue or filtered queue, for example.

Controlling the AMR at 316 may include various criteria for determining which pick task(s) and/or which drop-off task(s) to perform at 206, such as including either the WES computer 105, onboard computer 103 of the AMR 102, or the traffic controller 113 determining whether the AMR 102 is in sufficiently close proximity to a particular task, or whether the AMR 102 can readily access the location of a particular task (i.e. whether there is congestion from other AMR or other operators). If the AMR is not within sufficiently close proximity or the area is congested for a particular task, the WES computer 105 and/or onboard computer 103 retains that task for completion at a later time, such as the next time that it is opportunistic or advantageous to do so, in view of the other tasks in the AMR queues (e.g. 120 or 122). If the AMR 102 is within sufficiently close proximity of a particular task, the onboard computer 103 controls the AMR 102 to perform or carry out 206 that task (FIGS. 1 and 2). Upon completion of one or more tasks at 206 (FIGS. 1 and 2), the onboard computer 103 of the AMR 102 may return to step 302 (FIG. 3) to select another task(s) at 204 (FIGS. 1 and 2), or alternatively, the RCS computer 111 and fleet manager 112 may intervene and assign a task or tasks to the AMR 102 at 216 (FIGS. 1 and 2), such as when the AMR 102 is not locked or temporarily assigned to a task queue or filtered queue, for example.

It is contemplated that more or fewer of the tasks and functions performed by the WES 104 and/or more or fewer of the tasks and functions performed by the onboard computer 103 of the AMR 102 in reference to method 300 and the illustrative embodiment of FIG. 3 may be handled or performed by the other of the WES 104 or AMR onboard computer 103, or optionally the WES 104 and AMR onboard computer 103 may coordinate to perform some of such tasks and functions, for example.

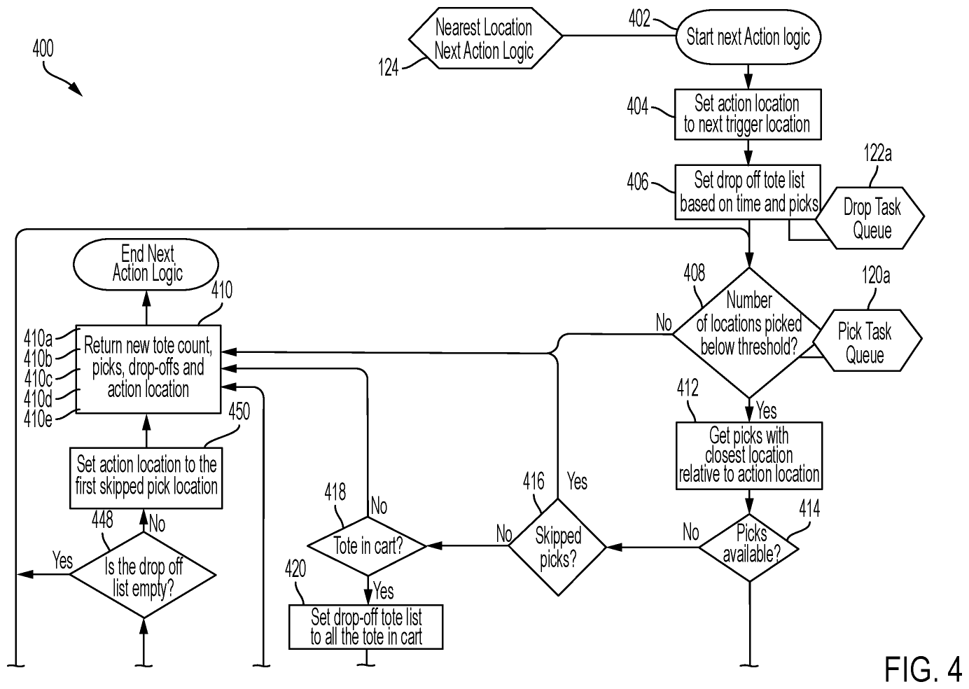

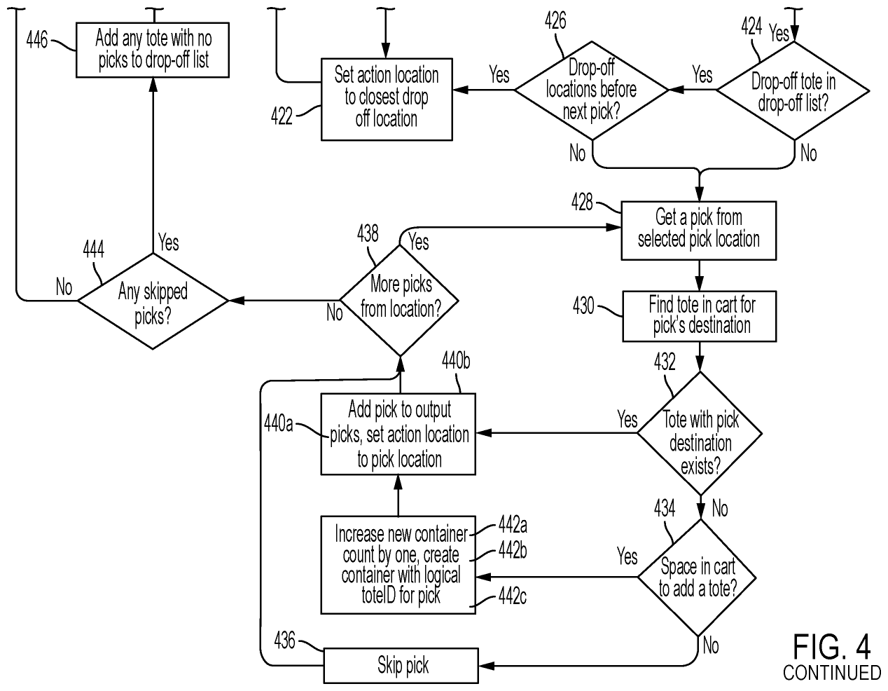

Referring now to the illustrative embodiment of FIG. 4, an exemplary method 400 is directed to selecting pick tasks (e.g. pick tasks in the form of task queues or filtered queues) from the pending workflow list 108 based on the current and/or future location of an AMR 102 and/or determining whether to drop off a container or item carried on the AMR 102 based on the current and/or future location of the AMR 102. Method 400 may be incorporated into method 200 of FIGS. 1 and 2 for selecting a task at 204 from a task queue or filtered queue (as provided from the pending workflow list 108) and/or selecting another task at 204a or 212 from the task queue (e.g. for pick tasks). For purposes of this disclosure, method 400 will be discussed as though integrated into method 200 of FIGS. 1 and 2 and utilizing the system 100 of FIGS. 5-8. However, it will be appreciated that method 400 of FIG. 4 may be adapted for other systems and functions to which it is well-suited. In certain aspects, method 400 may be referred to as including or providing a “nearest location next action” logic or algorithm 124 for determining the next action/task/mission for an AMR 102 to perform or add to its workflow list as a function of the location of the AMR 102 relative to tasks on pending workflow list 108. The nearest location next action logic 124 is controlled and performed by and/or integrated with the AMR workflow 107. Method 400 is particularly well-suited for AMR 102 configured to receive and support multiple storage receptacles or totes, each provided for receiving one or more article, item, product, good, etc. An AMR 102 may be referred to as a cart in that it is configured to receive multiple items and totes. In this manner, an AMR 102 may make picks for more than one different order, wherein items for each different order may be allocated to a different one of the totes on the AMR 102. For example, one tote present on an AMR 102 may be allocated for items for a particular retail order and another tote on the same AMR 102 may be allocated for items for a particular e-commerce order. Method 400 may be adapted to utilize the majority or all of the capacity of the totes on the AMR 102 and substantially all times. In other words, the nearest action next location logic may be performed to select new pick tasks as long as there is space or capacity available in totes on the AMR 102 to accept the contents of a pick task. The nearest action next location logic may be configured to evaluate the highest priority tasks in sequence until the threshold for picks (i.e. the capacity of the AMR) is met or maximized. Once the pick threshold of the AMR 102 is reached, the AMR 102 must then perform at least one drop-off task in order to make space available for additional pick tasks.

While method 400, as exemplified in the illustrative embodiment of FIG. 4, is directed to picking tasks and/or drop-off tasks, it will be appreciated that the framework and concept of the nearest location next action 124 may be adapted for various order fulfillment and material handling tasks and for different use cases than detailed herein. For example, method 400 may be adapted for sequencing, prioritizing, and/or optimizing inventory putaway tasks to place inventory items into storage, such as opportunistic decant and storage tasks, or adapted for sequencing, prioritizing, and/or optimizing packing and shipping tasks, such as consolidation of picked items into assigned shipping containers. It will be appreciated that the pick task queue 120a and drop-off task queue 122a of FIG. 4 are provided as examples of open-ended mission requests/task queues as described above with respect to system 100 and method 200, and are not intended to be limiting as to the plurality of potential task types to which system 100, method 200, or method 400 may be adapted to perform.

Method 400 includes the WES 104 and/or AMRs onboard computer 103 starting the nearest action next location logic 124 at 402 and setting at 404 an ensuing, current, or active action location defined as a location at which the WES 104 and/or onboard computer 103 must make the next task selection decision and/or control the AMR to perform the next task (e.g. performance of a drop-off task) to a subsequent task location (FIG. 4). In other words, the ensuing action location set at 404 defines a trigger such that as the AMR 102 reaches the ensuing action location or performs the task at the ensuing action location, the WES 104 and/or onboard computer 103 is triggered to continue the process of performing the nearest location next action logic 124 of method 400 at step 406 and subsequent steps, as appropriate. It will be appreciated that the ensuing action location may be the location at which the AMR 102 presently occupies, such that some of the pick tasks and/or drop-off tasks in the respective pick task queue 120 and/or drop-off task queue 122 may be performed without the AMR 102 having to travel to a new destination/task location. Alternatively, the ensuing action location may be represented by a random location in the facility. In another alternative, the ensuing action location may be represented by a location of a pick task or a drop-off task that is already presently assigned to or selected by the AMR workflow 107. In this manner, the nearest location next action logic 124 may be actively evaluating tasks to be performed at the current location of the AMR 102 or may be actively evaluating tasks to be performed at a future location within the planned travel path of the AMR 102.

In the illustrated embodiment of FIG. 4, the method 400 includes setting or determining at 406 a prioritized or optimized tote or item drop-off list or queue 122 of items or totes to be dropped off based at least on the time it will take to complete a drop-off task (i.e. cycle time), the pick threshold or capacity available on the AMR 102 to perform additional picks, and/or the location of previously selected pick tasks to be performed by the AMR 102. The WES 104 and/or onboard computer 103 captures or evaluates a subset of eligible tasks in the pending workflow list 108 based on the location of the AMR. In this manner, the onboard computer temporarily selects and “checks out” the subset of tasks while it evaluates the tasks to determine if any of the subset of tasks is an optimal or advantageous tasks for the AMR to perform. Any tasks from the subset determined to be optimal or advantageous are added to the AMR workflow 107, and the remaining subset are returned or “check back in” to the pending workflow list 108 for later selection/evaluation by that AMR 102 or another AMR. If the AMR 102 receives a task from the WES 104 (i.e. a task in the assigned task queue) with a special attribute which prevents the AMR from performing and/or completing the task, then the WES 104 will retain control of that task and the AMR 102 may then begin operating in a self-assignment or self-tasking mode. Other contemplated scenarios include that an AMR may startup in a self-assignment/self-tasking mode, such that the AMR does not require any initial instruction or task assignment from the WES 104 or fleet manager 112, for example.

The WES 104 and/or onboard computer 103 determines at 408 whether the AMR 102 is at capacity, i.e. whether the AMR 102 is at or above its threshold of filled capacity and allotted capacity for previously selected pick tasks in the AMR workflow 107 that are already assigned to unfilled or under-filled totes on the AMR 102. If it is determined at 408 that the pick threshold is met, i.e. the number of locations to be picked is not below the threshold (i.e. is at or above the threshold), the method 400 includes a combined step 410 of the WES 104 and/or onboard computer 103 counting or determining at 410a the number of totes on the AMR 102, returning at 410b the selected pick tasks to the AMR workflow 107, returning or checking back in at 410c any of the remaining, non-selected ones of the subset of checked out tasks to the pending workflow list 108 for future selection/check out, returning at 410d drop-off tasks to the AMR workflow 107 to be performed before subsequent pick tasks are to be or can be performed, and returning at 410e the ensuing action location to the AMR workflow 107 to facilitate guiding the AMR 102 to the ensuing action location. As such, at combined step 410, the nearest location next action logic 124 provides an “output result” (OR) to direct the onboard computer 103 to control the AMR 102 to perform various tasks or adjust the AMR workflow 107, including controlling the AMR 102 to drop off containers or totes, add picks to an existing container on the AMR, or add a new tote to the ARM and specify which pick tasks/orders to associate with it. The combined step 410 is configured to return or compile all of the applicable actions 410a-410e in a single response, thereby provided a relatively short function in terms of processing time. In one exemplary embodiment, the AMR workflow 107 may order the sequence of actions 410a-410e in a particular manner, such as: (i) first adding new containers to the AMR; (ii) then performing pick tasks to any existing containers on the cart; and (iii) and then dropping off containers or totes from the AMR that are completed or have exceeded their max cycle time (as described in further detail below). The WES 104 and/or onboard computer 103 then terminates or ends the nearest location next action logic 124, and may direct the AMR 102 to perform any tasks in the AMR workflow 107, such as in the pick task queue 120 or the drop-off queue 122 if applicable, and/or return to 402 and begin the nearest location next action logic 124 again (FIG. 4), either at the current location of the AMR 102 or at a future or ensuing location (e.g. trigger location) along the travel path of the AMR 102.

If it is determined at 408 that the pick threshold is not met, i.e. the number of locations to be picked is below the threshold, the method 400 includes selecting 412 the pick tasks in the checked out, eligible subset of tasks that are closest to the ensuing action location.

The WES 104 and/or onboard computer 103 evaluates and determines at 414 whether there are picks available from the tasks selected at 412, with available picks comprising those nearby the ensuing action location and which the AMR 102 has capacity to perform (e.g. receive the items for the pick task) or which the AMR 102 is assigned to perform (e.g. whether the available picks corresponding to an order already assigned to one of the totes on the AMR 102) (FIG. 4). If there are not picks available at 414 from the tasks selected at 412, the WES 104 and/or onboard computer 103 determines 416 whether there are any picks that were skipped over, i.e. whether any of the pick tasks from the tasks selected at 412 remain to be performed. For example, if the onboard computer 103 selects three (3) pick tasks at 412 and the WES 104 and/or onboard computer 103 determines that none of those picks are available at 414, then those three selected picks are considered “skipped” picks and remain unselected and to be performed. Similarly, if the onboard computer 103 selects four (4) pick tasks at 412 and the WES 104 and/or onboard computer 103 determines that two (2) of those picks are available at 414, then those other two (2) selected picks are considered skipped picks and remain unselected and to be performed. If it is determined at 416 that there are skipped picks, the WES 104 and/or onboard computer 103 goes to step 410 and returns or checks back in 410c the remaining, skipped tasks to the pending workflow list 108 for future selection/check out and then ends the nearest location next action logic 124 at 249. If it is determined at 416 that there are not any skipped picks, the WES 104 and/or onboard computer 103 determines 418 whether there is one or more tote on the AMR 102 that is ready for drop off, such as if the tote contains all of the required items for an order or if the tote cycle time has expired and that tote needs to be dropped for future pickup, for example. If it is determined at 418 that there are no totes on the AMR 102 to be dropped off, the WES 104 and/or onboard computer 103 goes to step 410 and counts or determines 410a the number of remaining totes on the AMR 102 that were not ready for drop off and returns 410e the ensuing action location to the AMR workflow 107 to facilitate guiding the AMR 102 to the ensuing action location. The WES 104 and/or onboard computer 103 then ends 249 the nearest location next action logic 124. In the event that it is optimal or advantageous to offload or drop off every tote on the AMR 102 due to a lack of viable or optimal tasks to be performed in the area proximate the AMR based on the content and capacity of the totes thereon, the WES 104 and/or onboard computer 103 may determine at 418 that every tote on the AMR 102 is ready for drop off at the ensuing location or at a subsequent location where a particular tote is more desired or optimal.

If it is determined at 418 that there are totes on the AMR 102 to be dropped off, the WES 104 and/or onboard computer 103 sets, adjusts, or updates 420 a tote drop-off list 122a of the AMR workflow 107 (such as a subset of the drop-off queue 122, for example) comprising the totes that are ready for drop-off (FIG. 4). For example, if the WES 104 and/or onboard computer 103 determined at 418 that all of the totes on the AMR 102 are to be dropped off, the computer sets 420 the tote drop-off list to include every tote on the AMR 102. The totes on the tote drop-off list 122a may be all assigned for drop off together at the ensuing action location, however, it may be more commonly advantageous that the totes on the tote drop-off list each have a preferred or most advantageous drop location, which may be the same or different drop location as one or more of the other totes on the tote drop-off list. Once the drop-off list 122a has been set or adjusted at 420, the WES 104, traffic controller 113, or onboard computer 103 sets 422 the ensuing action location to the nearest or closet drop-off task on the drop-off list 122a such that the next action to be performed by the AMR 102 will be that nearest or closest drop-off task. The onboard computer 103 then goes to step 410 and returns 410d the set or adjusted drop-off list 122a and the updated ensuing action location to the AMR workflow 107 to be performed.

If it is determined at 414 that there are picks available from the tasks selected at 412, the WES 104 and/or onboard computer 103 determines 424 whether there are any drop-off tasks present in the drop-off list 122a to be performed by the AMR 102. If there are drop-off tasks present in the drop-off list 122a, the WES 104 and/or onboard computer 103 makes a determination at 426 whether any of the drop-off tasks present in the drop-off list 122a are to be performed at a location the is closer to the AMR 102 than any of the pick tasks that were available at 414. If there is a drop-off tasks on the drop-off list 122a that is closer than any of the picks available at 414, the WES 104 and/or onboard computer 103 sets or adjusts 422 the ensuing action location to the nearest or closet drop-off task on the drop-off list 122a such that the next action to be performed by the AMR 102 will be that nearest or closest drop-off task. The onboard computer 103 then goes to step 410 and returns 410d the set or adjusted drop-off list 122a and the updated ensuing action location to the AMR workflow 107 to be performed.

If it is determined either (i) at 424 that are no drop-off tasks present in the drop-off list 122a or (ii) at 424 that there are drop-off tasks present in the drop-off list 122a but that the closet pick location available at 414 is closer to the AMR 102 than the closet drop-off location in the drop-off list 122a, the WES 104 and/or onboard computer 103 gets or selects 428 a pick operation from the pick tasks selected at 412 based on which of the tasks at 412 are closest to the AMR 102. In other words, the WES 104 and/or onboard computer 103 chooses the pick task(s) (from the available picks determined at 414) that are at the closet location to the AMR 102. After selecting one pick task at 428 from the next closest pick location relative to the AMR 102, the computer evaluates different aspects of that particular tasks, starting at step 430 and continuing thereon with regard to that particular task. At 430, the WES 104 and/or onboard computer 103 evaluates whether any tote on the AMR 102 has capacity for placement of or to receive the item to be picked from the task selected at 428. Evaluation at 430 includes the WES 104 and/or onboard computer 103 determining 432 if there is a tote onboard the AMR 102 already contains items corresponding to the order or a tote that is already assigned to the same order as that of the item of the task selected at 428. For example, it may be determined at 432 that a tote (either empty or having items present) on the AMR 102 is assigned to be delivered to a destination in the facility that is identical to the location to which the item for the task selected at 428 must be delivered. For another example, it may be determined at 432 that a tote (either empty or having items present) on the AMR 102 is already assigned to the order corresponding to the item for the task selected at 428, e.g. the item for the task selected at 428 can then be combined with other items and/or a tote that is already assigned to that item's order.

If it is determined at 432 that there is not a tote on the AMR 102 that already contains items corresponding to the order or a tote already assigned to the same order as that of the item of the task selected at 428, the WES 104 and/or onboard computer 103 determines 434 whether the is space available on the AMR 102 to add a tote to the AMR 102 (FIG. 4). If there is not space available at 434 to add a tote to the AMR 102, the WES 104 and/or onboard computer 103 skips 436 the task selected at 428 (i.e. the computer decides not to add that task to the AMRs pick task queue) and then determines 438 whether there are any tasks remaining at 428 that have not been evaluated at 430 and following steps. If it is determined at 432 that there is a tote on the AMR 102 that already contains items corresponding to the same order or a tote already assigned to the same order as that of the item of the task selected at 428, the WES 104 and/or onboard computer 103 sets, adjusts, or updates 440a a pick task list 120a of the AMR workflow 107 (such as a subset of the pick task queue 120, for example) to include the task selected for evaluation at 430. For example, if it is determined at 432 that there is a tote on the AMR 102 with the same or similar attributes (i.e. destination and grouping/order ID) as the pick line (i.e. task selected at 428/item to be picked), and there is no item (e.g. item with a particular stock keeping unit (SKU)) with a different attribute currently in this tote (i.e. a SKU for a different order or having a different drop-off destination), the computer adds 440a the pick line/task to release from the assigned task queue or filtered queue (i.e. release or select the pick task and add it to the AMR workflow 107 to be picked into this tote, such that the pick line/task is not available to any other AMR).

The WES 104, traffic controller 113, or onboard computer 103 sets 440b the ensuing action location to the location corresponding to that pick task such that the next action to be performed by the AMR 102 will be at least one pick task at that pick task's location. The WES 104 and/or onboard computer 103 then determines 438 whether there are any tasks remaining at 428 that have not been evaluated at 430 and following steps, such that additional pick tasks may be ultimately added to the AMR workflow 107 at 440a.

If it is determined at 434 that there is space on the AMR 102 to receive another tote, the onboard computer 103 adds a task to the AMR workflow 107 to retrieve 442a another tote at some point prior to performing its next task. The WES 104 and/or onboard computer 103 increases 442b the count of totes on the AMR 102 by one to correspond to the tote that will be added and creates 442c a unique container or tote identification code or identifier for that tote that will be added (FIG. 4). The WES 104 and/or onboard computer 103 then sets, adjusts, or updates 440a a pick task list 120a of the AMR workflow 107 to include the pick line/task selected for evaluation at 430 and assigns that pick task to the new tote added at steps 442a-442c and then sets 440b the ensuing action location to the location corresponding to that pick task such that the next action to be performed by the AMR 102 will be at least one pick task at that pick task's location. The WES 104 and/or onboard computer 103 then determines 438 whether there are any tasks remaining at 428 that have not been evaluated at 430 and following steps, such that additional pick tasks may be ultimately added to the AMR workflow 107 at 440a.

If it is determined at 438 that there are remaining pick tasks remaining at 428 to be evaluated at 430 and following steps, the WES 104 and/or onboard computer 103 returns to step 428 etc., and continues this loop until all pick tasks selected at 428 are evaluated for addition to the AMR workflow 107. If it is determined at 438 that there are no remaining pick tasks remaining at 428 to be evaluated at 430 and following steps, the WES 104 and/or onboard computer 103 determines 444 whether there are any picks that were skipped over, i.e. whether any of the pick tasks from the tasks selected at 428 remain to be performed. For example, if the onboard computer 103 had selected three (3) pick tasks at 428 from the pick tasks selected at 412 based on which of the tasks at 412 are closest to the AMR 102, and the onboard computer 103 skipped all the three pick tasks at 436, then those three pick tasks are considered “skipped” picks at 444 and remain unselected and yet to be performed. Similarly, if the onboard computer 103 had selected four (4) pick tasks at 428 and the computer 103 adds two (2) of the four pick tasks to the AMR workflow 107 at 440a and skips the other two (2) pick tasks at 436, then those two (2) pick tasks are considered skipped picks at 444 and remain unselected and yet to be performed.

If it is determined at 444 that there are not any skipped picks, the WES 104 and/or onboard computer 103 returns to 408 and determines whether the AMR 102 is at capacity, etc. and continues this process until the AMR 102 is at capacity or at its threshold of pick tasks (FIG. 4). If it is determined at 444 that there are skipped picks, the WES 104 and/or onboard computer 103 adds 446 any tote present on the AMR 102 that is not currently assigned any pick tasks (i.e. no items currently assigned to be picked to that tote) to the tote drop-off list 122a. The WES 104 and/or onboard computer 103 then evaluates or determines 448 if there is/are presently any drop-off tasks on the AMR workflow's 107 tote drop-off list 122a. If it is determined at 448 that there are no drop-off tasks on the drop-off list 122a, i.e. the drop-off list 122a is empty, the WES 104 and/or onboard computer 103 returns to 408 and determines the AMR 102 is at capacity, etc., and continues this process until the AMR 102 is at capacity or at its threshold of pick tasks. If it is determined at 448 there are drop-off tasks on the drop-off list 122a, i.e. the drop-off list 122a is not empty, the WES 104, traffic controller 113, and/or onboard computer 103 sets 450 the ensuing action location to the location corresponding to the first and/or nearest skipped task location relative to the AMR 102 from the picks determined to have been skipped at 444, such that the next action to be performed by the AMR 102 will be at least one pick task at the location of the first and/or nearest pick tasks determined to have been skipped at 444. The WES 104 and/or onboard computer 103 goes to step 410 and performs any of the applicable sub-steps 410a-410e based on the results of the nearest location next action logic 124 as performed with method 400.

In an exemplary embodiment for retail order picking (i.e. picking of items present in a store for a customer to pick up at a later time), the method 400 may assign one or more tote on an AMR 102 to that particular retail order, and the assigned tote/totes will remain on that AMR until the entire retail order is completed (i.e. all the items for the order are picked in the assigned tote(s). In this manner, the logic 124 will not promote the tote(s) assigned to that order for drop off until all required picks are completed. This arrangement is particularly well-suited for retail settings in which order-to-pickup times are less critical. Further, this enables a single AMR 102 to pick and compile an order such that the order is pre-consolidated for drop-off at a customer pickup location or portal. Accordingly, once all picks selected at 412 are evaluated, the WES 104 and/or onboard computer 103 checks at 444 whether any picks were skipped and/or at 448 whether any totes are completed and ready to be dropped off. If there are totes determined to have been skipped at 444 and there are totes to be dropped off as determined at 448, the onboard computer 103 controls the AMR 102 to drop off the totes that are ready and proceeds to the next or nearest location of a skipped pick to evaluate and/or perform one or more pick task or one or more drop off task at that next or nearest location. The logic 124 may be repeated as the AMR 102 travels to that location or may be repeated once the AMR 102 has reached that location. If there are no totes completed or ready to be dropped off, as determined at 448, the WES 104 and/or onboard computer 103 controls the AMR 102 to evaluate with the logic 124 and/or perform one or more pick task at the AMR's current location or evaluate with the logic 124 and/or perform one or more pick task and/or drop-off task at a future location along the AMR's path, such as at the next or nearest location of one of the skipped picks as determined at 444.

In an exemplary embodiment for e-commerce order picking (e.g. picking of items from a warehouse facility to be shipped or delivered by a courier service to a customer's location), the method 400 may require that an AMR 102 complete the picking tasks for a particular tote or totes for an e-commerce order within a specified amount of time, i.e. a max tote cycle time threshold. If the AMR 102 does not complete the picking tasks within that threshold, the WES 104 and/or onboard computer 103 adds that tote or totes to the drop-off list 122 to be dropped off by the AMR 102 either immediately or at the next advantageous opportunity. In this manner, the order does not stagnate for too long on one AMR 102, which it is possible that another AMR 102 may be able to retrieve those totes and complete the order in a shorter period as compared to the initial AMR. This is particularly beneficial when an e-commerce order is to be expedited, such as an order required same-day or next day delivery and thereby must be provided to a courier service in sufficient time to ensure that the order can be delivered to the customer on time. It will be appreciated that this arrangement may also be adapted for use in retail settings, such as if a customer places an expedited order and that two or more AMR resources can be coordinated to optimize the picking tasks for that retail order to adequately service the expedited order in the limited time allotted.

The following provides an exemplary algorithm, logic, or criteria for determining when to control an AMR 102 to drop off one or more of the containers or totes present on the AMR. The logic described herein may be referred to as a “drop-off decision criteria”, which is performed by the WES 104 and/or onboard computer 103 to determine which, if any totes are complete and/or ready to be dropped off. The onboard computer 103, and therefore the AMR 102, may perform the majority, if not all, of the drop-off decision making process. Alternatively, the WES 104 may perform the majority, if not all, of the drop-off decision making process In other words, the AMR 102 may be enabled to independently determine when is the most opportune, advantageous, or critical time and location to make a drop off of a tote. The drop-off decision criteria may be performed as a sub-function of either of method 300 (in conjunction with the next action logic 118) or method 400 (in conjunction with the next action logic 124), although it will be appreciated that the drop-off decision criteria described herein may be adapted for use in other settings and/or with modified criteria to that described below. For purposes of illustrating examples of the drop-off decision criteria, the following examples will be discussed in relation to aspects of method 400 of FIG. 4, although it should be appreciated that the criteria are also applicable and/or adaptable for implementation into method 300 of FIG. 3. The WES 104 and/or onboard computer 103 may promote or add a drop-off tasks for a particular tote to the drop off task queue 122a based on the following sets of criteria:

### Exemplary Drop-Off Decision Criteria 1

a. the WES 104 and/or onboard computer 103 determines at 428 etc. that there are no more pick tasks available in the system with the same attributes (e.g. destination and grouping ID) as the tote being evaluated at 428 etc.;
b. the WES computer 105 and/or onboard computer 103 determines at 426 that there is a drop-off location available on the travel path of the AMR 102 before the pick task queue 122a of the AMR 102 falls below the maximum capacity or threshold of the AMR as determined at 408; and
c. that the next or nearest pick task in the pick task queue 120a is further away than the drop-off location for the tote being evaluated.

If all of above criteria are met, the WES 104 and/or onboard computer 103 controls the AMR 102 to drop off that tote and start the next pick task in the queue 120a and/or start the nearest location next action logic 124 from the ensuing drop-off location on the pick path.

### Exemplary Drop-Off Decision Criteria 2

a. the WES computer 105 and/or onboard computer 103 determines that a tote on the AMR 102 exceeds the max tote cycle time threshold allotted, which is defined as: current time minus the first pick time of the tote which is greater than the max tote cycle time (i.e. current time−first pick time of the tote>max tote cycle time);
b. the tote being evaluated is assigned to an e-commerce order having a max tote cycle time threshold allotted in order to meet the order timeline requirement (e.g. reaching a courier in time to arrive at the customer's destination the following day);
c. that tote has exceeded its max tote cycle time threshold; and
d. the WES computer 105 and/or onboard computer 103 determines at 426 that there is a drop-off location available on the travel path of the AMR 102 before the pick task queue 122a of the AMR 102 falls below the maximum capacity or threshold of the AMR as determined at 408.

If all of above criteria are met, the WES 104 and/or onboard computer 103 controls the AMR 102 to drop off that tote and start the next pick task in the queue 120a and/or start the nearest location next action logic 124 from the ensuing drop-off location on the pick path.

### Exemplary Drop-Off Decision Criteria 3

a. the WES computer 105 and/or onboard computer 103 determines at 432 that the tote being evaluated already contains the same SKU but with a different generic attribute from the SKU to be picked to the tote. In other words, the computer 103 determines that the next pick task along the pick sequence (i.e. in the pick task queue 120a) is a SKU that has different SKU attributes from the SKU that has already picked into the tote being evaluated.

If the above criteria is met, the WES 104 and/or onboard computer 103 controls the AMR 102 to drop off that tote and start the next pick task in the queue 120a and/or start the nearest location next action logic 124 from the pick task location which the AMR 102 currently occupies before proceeding the next drop-off location on the pick path in the drop-off list 122a.

### Exemplary Drop-Off Decision Criteria 4

a. the WES computer 105 and/or onboard computer 103 determines at 432 that the next pick task in the pick queue 120a has a different attribute (e.g. destination or grouping ID) from any of the totes presently on the AMR 102;
b. the WES computer 105 and/or onboard computer 103 determines at 434 that there is no capacity or space on the AMR 102 to take on or receive another tote; and
c. the WES computer 105 and/or onboard computer 103 (i) recognizes at 446 that there is/are tote(s) on the AMR 102 that are completed (i.e. have no more picks required) and/or (ii) the computer 103 recognizes that one or more totes exceeds its max tote cycle time threshold (for totes assigned to e-commerce orders only).

If the above criteria is met, the WES 104 and/or onboard computer 103 controls the AMR 102 to drop off that tote and start the next pick task in the queue 120a and/or start the nearest location next action logic 124 from the next or nearest pick location of a pick task in the pick queue 120a that matches the attributes of the evaluated pick task (e.g. has the same destination or grouping ID as the evaluated pick task).

It may be preferable to control the AMR 102 in a manner which prioritizes pick tasks over drop-off tasks, particularly when a pick task in the pick task queue 120a is determined at 426 to be closer to the AMR than any of the drop-off tasks in the drop-off list 122a (FIG. 4) or when an AMR 102 is evaluating between pick and drop off tasks at the AMRs current location. For example, if there are any pick tasks in the queue 120a remaining for the AMR 102 to perform at a particular location at which a tote is to be ultimately dropped off, those pick tasks are picked by the AMR before finalizing or “calling” the output result at 410 of the nearest location next action logic 124, and before the AMR 102 drops off the tote such that the tote is completed before drop off and ultimately before the AMR 102 moves from that drop-off location.

Conversely, if totes are to be dropped off first (such as because it is determined at 426 that the next or nearest drop-off location is closer to the AMR 102 than the next pick location), the onboard computer 103 performing the nearest location next action logic 124 can add new totes to the locations on the AMR 102 previously occupied by the dropped-off totes (such as with a robotic arm provided on the AMR) and assign new, empty, or unassigned totes to receive items from pick tasks without waiting for the sequence or iteration of the nearest location next action logic 124.

In another example of prioritizing pick tasks over drop tasks (assuming that a drop-off task is not nearest or closest to the AMR 102 relative to the next closest pick task), the assumption of the nearest location next action logic 124 is that the WES 104 and/or onboard computer 103 is deciding when to drop off a full or complete container secondary to any more optimal pick tasks available to the AMR 102. As previously described, the nearest location next action logic 124 decides when to drop off a container when the max tote cycle time threshold exceeded or the tote is “timed out”, or when it is determined at 428 that there are no picks available or remaining for the tote's destination (e.g. the tote is complete with regard to pick tasks available in that particular region of the warehouse or facility). If the tote times out, a drop-off evaluation is performed for that tote at steps 424/426 and/or 446/448 of method 400 each time or iteration that the nearest location next action logic 124 runs. If it is determined at 432 that there are no pick tasks remaining for a particular tote's destination, a drop-off evaluation is performed for that tote at steps 446/448 after each pick location is evaluated at step 428, etc. If tote is ready for drop off, it is added to the drop-off list 122a to be dropped off immediately if the AMR 102 is presently at a drop-off location or if the AMR's next location is a drop-off location. However, if the AMR 102 is not presently at a drop-off location (as determined upon reevaluation at 424/426) or the AMR's next location along its travel path is not a drop-off location (as determined at 426), but instead only a next pick task location, the nearest location next action logic 124 will not return (i.e. add the drop-off task to the drop-off task list 122a) a command to drop-off that tote even though it is eligible/ready for drop-off. In this manner the AMR 102 remains on its optimal pick path and can thus continue to pick forward with less drop-off disruption, and the AMR 102 can drop-off the tote at a later, more optimal location.

The following provide some simplified or summarized examples of “output results” returned at 410 from method 400 and nearest location next action logic 124 of FIG. 4.

In one exemplary pick/drop sequence and output result, the WES 104 and/or onboard computer 103 determines at 408 that the AMR 102 has capacity for pick tasks in the pick task queue 120a and at 414 that one (1) pick task is available at location 1 and that one (1) pick task is available location 10 within a facility, and determines at 424 that one (1) drop-off task is available in the drop-off queue 122 at location 8 of the facility. In a first iteration of logic 124, the AMR's next trigger location or ensuing action location is set by the WES 104, traffic controller, and/or onboard computer 103 at 440b to location 1 for the one pick task at that location and the logic 124 returns to step 408. In the second iteration the WES 104 and/or onboard computer 103 evaluates the next closest task location, which is the drop-off location at location 8. The WES 104 and/or onboard computer 103 determines at steps 424 and 426 that the drop-off task is before the next pick task to be evaluated, and thus sets 422 the second location of the AMR 102 as location 8 and returns the drop-off call at 410d. In a third iteration of logic 124, the WES 104 and/or onboard computer 103 evaluates the next task, which is the pick task at location 10. The logic 124 returns or sets 440b the third location for the AMR to location 10 for the one pick task at that location and the logic 124 returns that pick task at 410b and the logic 124 is terminated.

In another exemplary pick/drop sequence and output result, the WES 104 and/or onboard computer 103 determines at 408 that the AMR 102 has capacity for pick tasks in the pick task queue 120a and at 414 that one (1) pick task is available at location 1 and that one (1) pick task is available location 10 within a facility, and determines at 424 that there are no (0) drop-off tasks ready or available in the drop-off queue 122 along the AMR's current travel path. In a first iteration of logic 124, the AMR's next trigger location or ensuing action location is set by the onboard computer 103 at 440b to location 1 for the one pick task at that location and the logic 124 returns to step 408. In the second iteration the AMR's next trigger location or ensuing action location is set by the WES 104, traffic controller 113, and/or onboard computer 103 at 440b to location 10 for the one pick task at that location and the logic 124 returns to step 408. The WES 104 and/or onboard computer 103 then determines at step 414 that there are no pick tasks available, at 416 that there are no skipped picks, and at 418 that there are no totes on the AMR 102 ready for drop off. Thus, the WES 104 and/or onboard computer 103 and logic 124 return at 410b the two pick tasks (one at location 1 and one at location 10) the logic 124 is terminated. Wherein, the pick sequence is set such that the AMR 102 performs the pick at location 1 and then travels to location 10 to make the pick there. While at location 1, the WES 104, traffic controller 113, and/or onboard computer 103 sets the ensuing action location at 440b to location 10. When the AMR 102 reaches location 10, the onboard computer runs logic 124 to determine the next task or task sequence the AMR will perform after completion of the pick task at location 10.

It is contemplated that more or fewer of the tasks and functions performed by the WES 104 and/or more or fewer of the tasks and functions performed by the onboard computer 103 of the AMR 102 in reference to method 400 and the illustrative embodiment of FIG. 4 may be handled or performed by the other of the WES 104 or AMR onboard computer 103, or optionally the WES 104 and AMR onboard computer 103 may coordinate to perform some of such tasks and functions, for example.

It is contemplated that the adaptive/dynamic self-selecting AMR tasking functionality may be integrated directly with the AMR's ROS, enabling each AMR to directly control the “driving” or physical control aspects of the AMR, such as route calculation, for example. Accordingly, AMRs enabled to control their own driving aspects may support or enable quicker response from the AMR and reduce cycle times for potential and/or additional workflow specific movements and controls, e.g. control a robotic picking arm on an AMR. This may enable the AMR to not only be self-tasking but to have increased autonomy, such as a function of actions based on localized run-time workflow parameters.

The systems and methods of the present disclosure may include or utilize structure, function, and/or processes (such as for order prioritization and sequencing at the WES, e.g. sliding bubble approach) such as those disclosed in commonly owned and assigned U.S. Patent Applications Pub. No. 2022/0106121A1, published Apr. 7, 2022 and entitled SYSTEM AND METHOD FOR ORDER FULFILLMENT SEQUENCING AND FACILITY MANAGEMENT, Pub. No. 2022/0245583A1, published Aug. 4, 2022 and entitled AUTOMATED ORDER FULFILLMENT WITH OPPORTUNISTIC DECANT OPERATIONS, and Pub. No. 2022/0309447A1, published Sep. 29, 2022 and entitled AUTONOMOUS MOBILE ROBOT BASED MATERIAL MOVEMENT SYSTEM AND METHOD, each by Dematic Corp. of Grand Rapids, MI, the disclosures of which are hereby incorporated herein by reference in their entireties. Systems and methods may be adapted (such as for order prioritization and sequencing at the WES, e.g. sliding bubble approach) from those disclosed in commonly owned and assigned U.S. Pat. No. 10,618,736, issued Apr. 14, 2020, and U.S. Pat. No. 10,882,696, issued Jan. 5, 2021, each to Dematic Corp. of Grand Rapids, MI, the disclosures of which are hereby incorporated herein by reference in their entireties.

Thus, the illustrative and exemplary embodiments of the present invention provide a method and system in which AMR are substantially independent, i.e. not reliant on an external or remote robot control system, to select tasks to perform within a material handling facility. The method enables AMR to self-select tasks to perform and utilizes a computer based WES, which maintains, organizes, and prioritizes a pending workflow list of tasks to be performed within the facility. Onboard computers of the AMRs are adapted to communicate with the WES and to self-select a task to perform from the pending workflow list (e.g. a task queue or filtered task queue) provided or maintained at the WES. In this manner, the AMR do not require direction, control, or assignment from the WES or other control system to select tasks or operations. Thus, the AMR are adapted to independently self-select tasks when in need of a task to perform, such as when the AMR has underutilized capacity.

Changes and modifications in the specifically described embodiments can be carried out without departing from the principles of the present invention, which is intended to be limited only by the scope of the appended claims, as interpreted according to the principles of patent law including the doctrine of equivalents.

1. An automated material handling system having a plurality of autonomous mobile robots (AMR) for retrieving, transporting, and delivering items to and from locations within a material handling facility, said material handling system comprising:
a warehouse execution system (WES) comprising a computer that is programed with computer code that is adapted to maintain a pending workflow list comprising a plurality of tasks to be performed within the material handling facility; and
an AMR subsystem comprising at least a subset of said plurality of AMRs of said automated material handling system, an onboard computer provided with each of at least some of said plurality of AMRs of the AMR subsystem, wherein said onboard computer of each of said AMR is in communication with the WES, each of said onboard computers programmed with computer code that is adapted to select a task for the corresponding AMR to perform from the pending workflow list of the WES;
wherein a particular AMR is capable of performing the task selected from the pending workflow list by its onboard computer.

2. The automated material handling system of claim 1, wherein said selecting a task for the corresponding AMR to perform comprises selecting a task queue comprising a plurality of individual tasks from the pending workflow list of the WES.

3. The automated material handling system of claim 2, wherein upon completion of a task selected by an onboard computer of a particular AMR, the computer code of the onboard computer of that AMR is further adapted to select another task from the task queue.

4. The automated material handling system of claim 1, further comprising a robot controls system (RCS) having a computer that is programmed with RCS computer code and comprises a fleet manager, wherein said fleet manager and RCS computer code are adapted to receive at least some of the plurality of tasks from the pending workflow list of the WES and to control at least some of the plurality of AMRs within the material handling facility with the fleet manager as a function of the plurality of tasks received by the fleet manager.

5. The automated material handling system of claim 4, wherein said at least some of the plurality of AMRs within the material handling facility comprises at least some of the AMRs of said AMR subsystem and a plurality of AMRs that are not affiliated with the AMR subsystem.

6. The automated material handling system of claim 4, wherein the WES is adapted to lock an AMR to a particular task or task queue.

7. The automated material handling system of claim 6, wherein the WES is adapted to unlock the AMR from the particular task or task queue when either (i) the AMR has completed the task or task queue, or (ii) the WES determines that the AMR should be removed or redirected from that particular task or task queue.

8. The automated material handling system of claim 1, wherein each of the plurality of AMRs within the material handling facility are affiliated with said AMR subsystem, and each of the plurality of AMRs within the material handling facility are controllable by the fleet manager.

9. A method of task allocation for a material handling system having a plurality of autonomous mobile robots (AMR) for retrieving, transporting, and delivering items to and from locations within a material handling facility, said method comprising:
maintaining a pending workflow list comprising a plurality of tasks to be performed within the material handling facility using a computer based warehouse execution system (WES) that is programed with WES computer code;
selecting a task queue comprising at least one task from the pending workflow list of the WES and assigning the selected task queue to an AMR when that AMR is in need of a task to perform; and
performing the tasks on the selected task queue with the AMR.

10. The method of claim 9, further comprising the AMR selecting, with an onboard computer programmed with computer code, a task to perform from the task queue.

11. The method of claim 10, further comprising upon completion of the selected task with the AMR, the AMR onboard computer selecting another task from the task queue.

12. The method of claim 9, wherein said selecting another task from the task queue is performed as a function of at least one chosen from (i) the location of the AMR within the material handling facility and (ii) the material handling capability of the AMR.

13. The method of claim 9, further comprising using a computer based robot controls system (RCS) that is programmed with computer code and comprises a fleet manager, receiving at least some of the plurality of tasks from the pending workflow list from the WES and controlling at least some of the plurality of AMRs with the fleet manager as a function of the plurality of tasks received by the fleet manager.

14. The method of claim 13, further comprising determining, with a traffic controller in communication with the AMR, a route for the AMR to follow to perform the task selected by the AMR from the task queue.

15. The method of claim 13, wherein said controlling at least some of the plurality of AMRs comprises at least one chosen from (i) assigning tasks from the plurality of tasks received by the fleet manager to at least some of the plurality of AMRs, (ii) tracking statuses of tasks assigned to AMRs that were assigned tasks by the fleet manager, and (iii) assigning additional or new tasks from the plurality of tasks received by the fleet manager to at least some of the plurality of AMRs upon completion of a previous task.

16. The method of claim 10, wherein the task queue comprises one task, and further comprising upon completion of the selected task and task queue with the AMR, the AMR onboard computer selecting another task comprising one task from the pending workflow list of the WES.

17. The method of claim 16, further comprising using a computer based robot controls system (RCS) that is programmed with computer code and comprises a fleet manager, receiving at least some of the plurality of tasks from the pending workflow list from the WES and controlling at least some of the plurality of AMRs with the fleet manager as a function of the plurality of tasks received by the fleet manager.

18. The method of claim 17, further comprising the RCS tracking a status of a task selected by an onboard computer of an AMR, and upon completion of the selected task by that AMR, the fleet manager assigning an additional or new task from the plurality of tasks received by the fleet manager to that AMR.

19. The method of claim 10, wherein after the onboard computer of an AMR selects a task from the task queue, said method further comprising determining whether that AMR has capacity to perform at least one additional of the remaining tasks of the pending workflow list.

20. The method of claim 19, wherein if the AMR has capacity to perform at least one additional of the remaining tasks of the task queue, said method further comprising:
determining whether the AMR has containers to drop off;
wherein if the AMR does not have containers to drop off, the onboard computer of the AMR selecting an additional task for the AMR to perform from the task queue;
wherein if the AMR has containers to drop off, prioritizing (i) dropping of the containers as compared to (ii) selecting an additional task for the AMR to perform from the task queue while the containers to drop off remain on the AMR.

21. The method of claim 20, wherein said prioritizing comprises the onboard computer of the AMR selecting an additional task for the AMR to perform from the task queue while the containers to drop off remain on the AMR, and the onboard computer controlling the AMR to perform that additional task simultaneously and/or in sequence with the drop of the containers.

22. The method of claim 20, wherein said determining whether the AMR has capacity and said determining whether the AMR has containers to drop off are performed by the WES.

23. A method of task allocation for a material handling system having a plurality of autonomous mobile robots (AMR) for retrieving, transporting, and delivering items to and from locations within a material handling facility, said method comprising:
maintaining a pending workflow list comprising a plurality of tasks to be performed within the material handling facility using a computer based warehouse execution system (WES) that is programed with WES computer code;
selecting a task queue comprising at least one task from the pending workflow list of the WES and assigning the selected task queue to an AMR when that AMR is in need of a task to perform;
performing the tasks on the selected task queue with the AMR; and
further comprising the AMR selecting, with an onboard computer programmed with computer code, a task to perform from the task queue, and upon completion of the selected task with the AMR, the AMR onboard computer selecting another task from the task queue, wherein said selecting another task from the task queue comprises;
determining whether the AMR has capacity to pick the material required for at least one of the remaining tasks of the task queue;
wherein if the AMR lacks capacity, returning to determining whether the AMR has capacity to pick the material required for a different one of the remaining tasks on the task queue;
wherein if the AMR has capacity, the onboard computer selecting one of the tasks from the pending workflow list for which it has capacity;
wherein after the onboard computer selecting a task, determining whether the AMR is in sufficiently close proximity to the selected task;
wherein if the AMR is not within sufficiently close proximity of the selected task, returning to determining whether the AMR has capacity to pick the material required for a different one of the tasks on the task queue; and
wherein if the AMR is within sufficiently close proximity of the selected task, the onboard computer controlling the AMR to perform the selected task; and
wherein upon completion of the selected task, the onboard computer of the AMR selecting another one of the remaining tasks on the task queue, and determining whether the AMR has capacity to pick the material required for at that task.

24. The method of claim 23, wherein if the AMR lacks capacity, said method further comprising:
determining whether the AMR has containers to drop off;
wherein if the AMR does not have containers to drop off, returning to determining whether the AMR has capacity to pick the material required for a different one of the tasks on the task queue;
wherein if the AMR has containers to drop off, the onboard computer controlling the AMR to drop off the containers; and
wherein upon completion of dropping off the containers determining whether the AMR has capacity to pick the material required for at least one of the tasks remaining on the task queue.

25. The method of claim 23, wherein said selecting another task from the task queue further comprises determining whether the AMR has containers to drop off, and if so, determining whether the AMR has capacity to make an additional pick while the containers to drop off remain on the AMR.

26. The method of claim 25, wherein if the AMR has capacity to perform a particular additional pick task while the containers to drop off remain on the AMR, the onboard computer controlling the AMR to select that particular pick task and perform that pick task simultaneously and/or in sequence with the drop of the containers.
